(19) United States
(12) Patent Application Publication
(10) Pub. No.: US 2025/0317227 A1
(43) Pub. Date: Oct. 9, 2025

(54) METHOD, RADIO ACCESS NETWORK NODE, AND USER EQUIPMENT FOR HANDLING CLI

(71) Applicant: NEC Corporation, Minato-ku, Tokyo (JP)

(72) Inventors: Yinan QI, Tokyo (JP); Pravjyot DEOGUN, London (GB); Neeraj GUPTA, London (GB); Robert ARNOTT, London (GB)

(73) Assignee: NEC Corporation, Minato-ku, Tokyo (JP)

(21) Appl. No.: 18/864,687

(22) PCT Filed: Jun. 16, 2023
(86) PCT No.: PCT/JP2023/022495

§ 371 Date: Nov. 11, 2024

(30) Foreign Application Priority Data
Jun. 24, 2022 (GB) 2209320.7

(51) Int. Cl. H04B 17/309; H04B 7/06; H04L 5/14; H04W 56/00

(52) U.S. Cl. CPC H04B 17/346; H04B 7/0626; H04B 7/06952; H04L 5/14; H04W 56/0015

(57) ABSTRACT

A system is disclosed in which a victim base station configures at least one resource for measurement of cross link interference (CLI) caused by radio transmissions from a remote aggressor base station. The victim base station determines a level of the CLI based on a received signal strength value of a CLI reference signal from the remote aggressor base station. The received signal strength value may be a CLI channel state information-reference signal received power value or a base station specific CLI received signal strength indicator value.

### TECHNICAL FIELD

The present disclosure relates to a communication system.

### BACKGROUND ART

The present disclosure relates to a communication system. The disclosure has particular but not exclusive relevance to wireless communication systems and devices thereof operating according to the 3rd Generation Partnership Project (3GPP) standards or equivalents or derivatives thereof (including LTE-Advanced, Next Generation or 5G networks, future generations, and beyond). The disclosure has particular, although not necessarily exclusive relevance to, improved apparatus and methods for managing interference, such as cross link interference and remote interference, in time division duplex (TDD) communication bands.

Recent developments of the 3GPP standards are referred to as the Long Term Evolution (LTE) of Evolved Packet Core (EPC) network and Evolved UMTS Terrestrial Radio Access Network (E-UTRAN), also commonly referred as ‘4G’. In addition, the term ‘5G’ and ‘new radio’ (NR) refer to an evolving communication technology that is expected to support a variety of applications and services. Various details of 5G networks are described in, for example, the ‘NGMN 5G White Paper’ V1.0 by the Next Generation Mobile Networks (NGMN) Alliance, which document is available from https://www.ngmn.org/5g-white-paper.html. 3GPP intends to support 5G by way of the so-called 3GPP Next Generation (NextGen) radio access network (RAN) and the 3GPP NextGen core network.

Under the 3GPP standards, a NodeB (or an eNB in LTE, gNB in 5G) is the radio access network (RAN) node (or simply ‘access node’ or ‘base station’) via which communication devices (user equipment or ‘UE’) connect to a core network and communicate to other communication devices or remote servers. For simplicity, the present application will use the term RAN node or base station to refer to any such access nodes.

For simplicity, the present application will use the term mobile device, user device, or UE to refer to any communication device that is able to connect to the core network via one or more base stations. Although the present application may refer to mobile devices in the description, it will be appreciated that the technology described can be implemented on any communication devices (mobile and/or generally stationary) that can connect to a communications network for sending/receiving data, regardless of whether such communication devices are controlled by human input or software instructions stored in memory.

Simultaneous transmission and reception between a base station and user equipment (UE) is typically accomplished using different resources for uplink and downlink. The different resources may be different frequencies, in case of a frequency division duplex (FDD) scheme, or time resources, in case of a time division duplex (TDD) scheme. While FDD networks have separate uplink and downlink frequency bands, TDD networks utilize the same bandwidth, but allocate different time slots for uplink and downlink. In other words, in FDD the frequency domain resource is split between downlink (DL) and uplink (UL) whereas in TDD the time domain resource is split between DL and UL.

The appropriate duplex scheme to be used in a given scenario is broadly spectrum dependent, albeit with some overlap. Where lower frequency bands are used for communication, paired spectrum UL and DL resource allocations are generally employed and hence FDD is used. In contrast, for higher frequency bands the use of unpaired spectrum, and hence TDD, is becoming increasingly prevalent. Thus, TDD is widely used in commercial NR deployments. Given the significantly higher carrier frequencies supported by 5G, and that will be supported by future communication generations (6G and beyond) as compared to earlier communication generations, improved techniques for providing efficient use of unpaired spectrum are, and will continue to be, increasingly critical.

TDD networks may experience so-called cross-link interference, such as base station to base station (e.g. inter-gNB) cross link interference (CLI) and UE to UE (inter-UE) CLI.

Inter-gNB CLI may arise due to the base stations transmitting and receiving in the same frequency band, and may be in the form of, for example, adjacent-channel CLI, co-channel-CLI (or both) depending on the deployment scenario.

Inter-UE CLI may, for example, comprise CLI arising between UEs in the same cell (intra-cell CLI) as a result of both DL and UL transmissions can be running in parallel. In this scenario, interference may be observed by a UE, in the DL, from an adjacent subband which is used for UL transmission from another UE in the same cell. Such interference may, for example, arise due to non-linear distortions or frequency errors (e.g. doppler spread for DL reception). Interference may be expected, in particular, to be apparent for DL frequency resources which are close to UL resource elements (REs). This can become a severe issue when interference is experienced for DL reference signal (RS) reception (e.g., reception of Channel State Information RS (CSI-RS)) which has the potential to reduce system efficiency.

For subband non-overlapping FD operation both in subband (intra-subband) CLI and subband to subband (inter-subband) may be particularly relevant.

Another form of CLI is referred to as remote interference. Remote interference occurs when atmospheric conditions allow propagation of radio waves from a transmitter (base station) through the troposphere to remote locations (which may be as far as 300-400 km away) where these radio waves can interfere with local transmissions. 3GPP has introduced the so-called Remote Interference Management Reference Signal (RIM-RS) to mitigate the interference from downlink signals of remote base stations in case of atmospheric conditions that are favourable for producing troposphere bending of radio waves.

The normal transmission range of a base station (gNB) is a few kms. However, when troposphere bending of radio waves happens, even though the victim base station (gNB) and the aggressor base station are synchronized, the long transmission delay (may be up to 1.3 ms) of the signal from the aggressor base station that travels a few hundreds of kms will very likely cause interference to the UL reception of the victim base station. This may potentially affect hundreds of base stations.

Although the design of the frame structure in NR has already considered a flexible guard period (GP) to leave larger room for avoiding remote interference, it is necessary to study mechanisms for identifying when or how long will the long enough GP be configured.

3GPP Technical Report (TR) 38.828 V16.1.0 discusses Cross Link Interference handling and Remote Interference Management (RIM) for NR. This document describes that in Release 15 synchronized TDD was assumed to support co-existence between different networks operating on adjacent carriers in the same band. Interference between adjacent carriers is mitigated as long as all networks apply uplink and downlink at the same occasions.

Dynamic TDD describes a mode of operation in which a network adapts the DL/UL subframe pattern according to traffic conditions. If different nodes in the same network apply DL and UL at different times, then interference between different UEs and different base stations occurs. 3GPP has specified measurements to enable co-channel Cross Link Interference (CLI) mitigation within the same network. Dynamic TDD also causes interferers between networks on adjacent channels. Unlike the co-channel case, interference between adjacent channel networks cannot be coordinated. Instead, the interference is mitigated by transmitter and receiver selectivity (Adjacent Channel Leakage Power Ratio (ACLR) and Adjacent Channel Selectivity (ACS)) as analogue filtering is not generally feasible within an operating band.

A recent Release-16 work item (3GPP RP-193190) discusses further details of Cross Link Interference handling and Remote Interference Management for NR. A new, cell specific reference signal for RIM (referred to as ‘RIM-RS’) is introduced which implicitly indexes the Cell ID using a {time, frequency, sequence} triplet. There are two types of RIM-RS, a first type is transmitted by the victim node, and the second type is transmitted by the aggressor (due to reciprocity). An extra guard period is also provided for RIM.

Regarding UE-to-UE CLI management, the currently proposed approach relies on sounding reference signal (SRS) for UE-to-UE CLI measurement. The so-called SRS reference signal received power (SRS-RSRP) has been defined to enhance UE measurements for supporting CLI management. However, SRS-RSRP is up to manufacturer implementation and it is not clear how to use it to mitigate interference via scheduling and how to coordinate between two base stations.

Another 3GPP Release-16 work item (3GPP RP-213557) includes a study on evolution of NR duplex operation. This document is concerned with the subband non-overlapping full duplex scheme and potential enhancements on dynamic/flexible TDD. It also identifies possible schemes and evaluates their feasibility and performance. The objectives of this work item include, amongst others, studying inter-gNB and inter-UE CLI handling and identifying solutions to manage them, considering intra-subband CLI and inter-subband CLI in case of the subband non-overlapping full duplex; and studying the performance of the identified schemes as well as the impact on legacy operation assuming their co-existence in co-channel and adjacent channels.

### SUMMARY OF INVENTION

### Technical Problem

However, a key problem that has not been addressed in the previous releases and in the above 3GPP work items is gNB-to-gNB CLI. Specifically, there is no agreement yet on CLI measurement and reporting, gNB coordination mechanisms, and interference mitigation schemes.

It can be seen, therefore, that there is a need for enhancements for providing improved CLI handling between the base stations (of the same or different operators) and/or between the UEs, to help enable efficient dynamic/flexible TDD in communication networks.

The disclosure aims to provide apparatus and methods that at least partially address the above needs and/or issues.

### Solution to Problem

In one aspect, the disclosure provides a method performed by a radio access network node, the method comprising: identifying, based on respective configuration information for determining cross link interference (CLI), relating to a plurality of other radio access network nodes, an aggressor node as a source of the CLI in a cell of the radio access network node, outside a serving area of the aggressor node.

In one aspect, the disclosure provides a method performed by a radio access network node, the method comprising: transmitting at least one reference signal for measuring cross link interference (CLI) caused, outside a serving area of the radio access network node, by radio transmission from the radio access network node.

In one aspect, the disclosure provides a method performed by a radio access network node, the method comprising: configuring at least one resource for measurement of cross link interference (CLI), outside a serving area of a transmitter, caused by radio transmissions from the transmitter; and determining a level of the CLI based on a received signal strength value of a CLI reference signal received from the transmitter over the at least one resource.

In one aspect, the disclosure provides a method performed by a radio access network node, the method comprising: detecting, based on an associated reference signal, an occurrence of cross link interference (CLI) caused outside a serving area of another radio access network node, by radio transmission from the other radio access network node; and transmitting information indicating the occurrence of the CLI, to a node responsible for CLI management.

In one aspect, the disclosure provides a method performed by a user equipment (UE), the method comprising: transmitting an uplink signal such that an arrival time of the uplink signal at a radio access network node and an arrival time of a reference signal for measuring cross link interference (CLI) from another radio access network node are aligned.

In one aspect, the disclosure provides a radio access network node comprising means (for example a memory, a controller, and a transceiver) for identifying, based on respective configuration information for determining cross link interference (CLI), relating to a plurality of other radio access network nodes, an aggressor node as a source of the CLI in a cell of the radio access network node, outside a serving area of the aggressor node.

In one aspect, the disclosure provides a radio access network node comprising means (for example a memory, a controller, and a transceiver) for transmitting at least one reference signal for measuring cross link interference (CLI) caused, outside a serving area of the radio access network node, by radio transmission from the radio access network node.

In one aspect, the disclosure provides a radio access network node comprising: means (for example a memory, a controller, and a transceiver) for configuring at least one resource for measurement of cross link interference (CLI), outside a serving area of a transmitter, caused by radio transmissions from the transmitter; and means for determining a level of the CLI based on a received signal strength value of a CLI reference signal received from the transmitter over the at least one resource.

In one aspect, the disclosure provides a radio access network node comprising: means (for example a memory, a controller, and a transceiver) for detecting, based on an associated reference signal, an occurrence of cross link interference (CLI) caused outside a serving area of another radio access network node, by radio transmission from the other radio access network node; and means for transmitting information indicating the occurrence of the CLI, to a node responsible for CLI management.

In one aspect, the disclosure provides a user equipment (UE) comprising means (for example a memory, a controller, and a transceiver) for transmitting an uplink signal such that an arrival time of the uplink signal at a radio access network node and an arrival time of a reference signal for measuring cross link interference (CLI) from another radio access network node are aligned.

Aspects of the disclosure extend to corresponding systems, apparatus, and computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Although for efficiency of understanding for those of skill in the art, the disclosure will be described in detail in the context of a 3GPP system (5G networks), the principles of the disclosure can be applied to other systems as well.

The present disclosure is defined by the claims appended hereto. Aspects of the disclosure are as set out in the independent claims. Some optional features are set out in the dependent claims.

However, each feature disclosed in this specification (which term includes the claims) and/or shown in the drawings may be incorporated in the disclosure independently of (or in combination with) any other disclosed and/or illustrated features. In particular but without limitation the features of any of the claims dependent from a particular independent claim may be introduced into that independent claim in any combination or individually.

### Advantageous Effects of Invention

According to the present disclosure, it is possible to provide apparatus and methods that at least partially address the above needs and/or issues.

### BRIEF DESCRIPTION OF DRAWINGS

Example embodiments of the disclosure will now be described, by way of example, with reference to the accompanying drawings in which:

FIG. 1 illustrates schematically a mobile (cellular or wireless) telecommunication system to which example embodiments of the disclosure may be applied;

FIG. 2 is a schematic block diagram of a mobile device forming part of the system shown in FIG. 1;

FIG. 3 is a schematic block diagram of an access network node (e.g. base station) forming part of the system shown in FIG. 1;

FIG. 4 is a schematic block diagram of a core network node forming part of the system shown in FIG. 1;

FIG. 5 illustrates schematically some exemplary aspects of the present disclosure, as implemented in the system shown in FIG. 1;

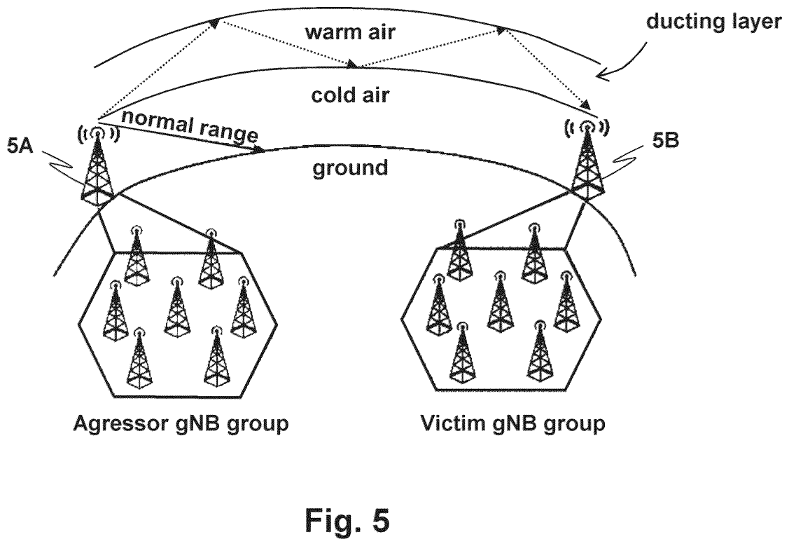

FIG. 6 illustrates schematically some exemplary aspects of the present disclosure, as implemented in the system shown in FIG. 1;

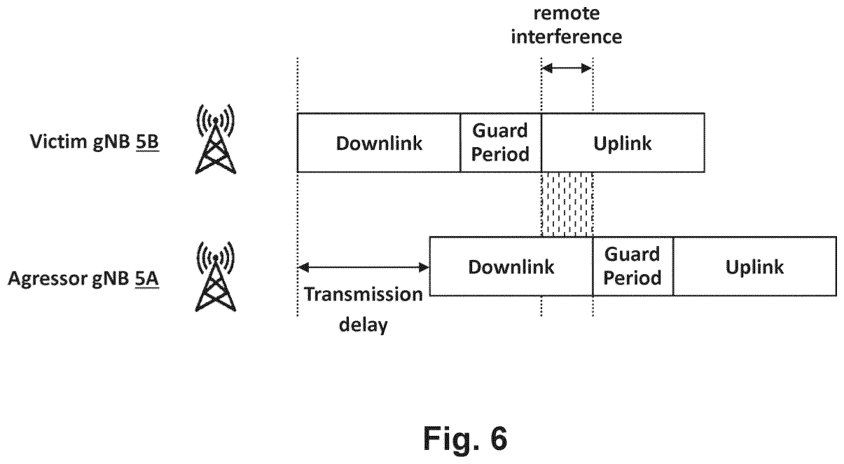

FIG. 7 illustrates schematically some exemplary aspects of the present disclosure, as implemented in the system shown in FIG. 1;

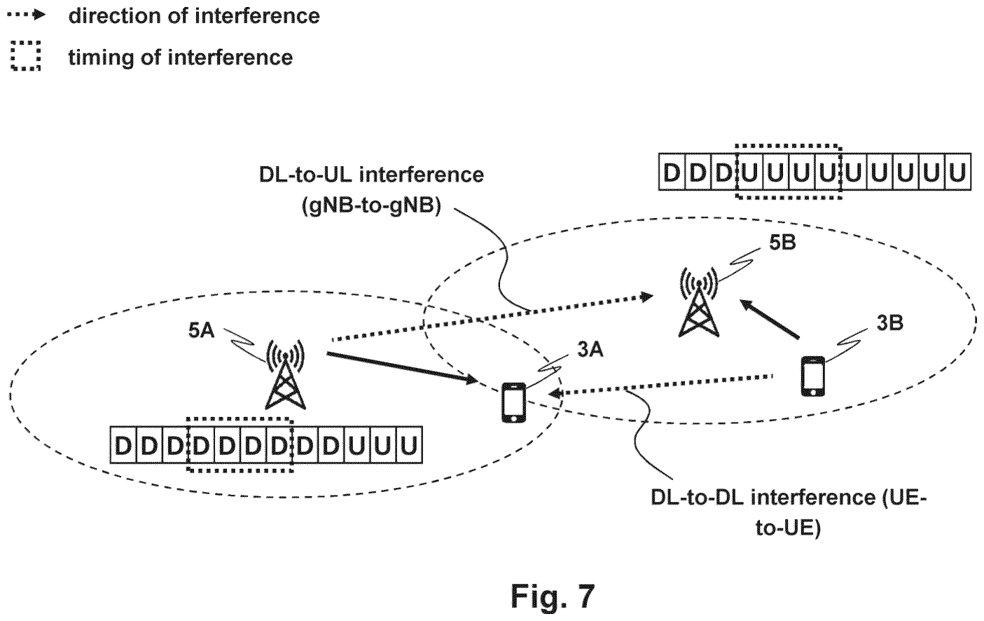

FIG. 8 illustrates schematically some exemplary aspects of the present disclosure, as implemented in the system shown in FIG. 1;

FIG. 9 illustrates schematically some exemplary aspects of the present disclosure, as implemented in the system shown in FIG. 1;

FIG. 10 illustrates schematically some exemplary aspects of the present disclosure, as implemented in the system shown in FIG. 1;

FIG. 11 illustrates schematically some exemplary aspects of the present disclosure, as implemented in the system shown in FIG. 1;

FIG. 12 illustrates schematically some exemplary aspects of the present disclosure, as implemented in the system shown in FIG. 1;

FIG. 13 illustrates schematically some exemplary aspects of the present disclosure, as implemented in the system shown in FIG. 1;

FIG. 14 illustrates schematically some exemplary aspects of the present disclosure, as implemented in the system shown in FIG. 1;

FIG. 15 illustrates schematically some exemplary aspects of the present disclosure, as implemented in the system shown in FIG. 1;

FIG. 16 illustrates schematically some exemplary aspects of the present disclosure, as implemented in the system shown in FIG. 1;

FIG. 17 illustrates schematically some exemplary aspects of the present disclosure, as implemented in the system shown in FIG. 1;

FIG. 18 illustrates schematically some exemplary aspects of the present disclosure, as implemented in the system shown in FIG. 1;

FIG. 19 illustrates schematically some exemplary aspects of the present disclosure, as implemented in the system shown in FIG. 1;

FIG. 20 illustrates schematically some exemplary aspects of the present disclosure, as implemented in the system shown in FIG. 1;

FIG. 21 illustrates schematically some exemplary aspects of the present disclosure, as implemented in the system shown in FIG. 1;

FIG. 22 illustrates schematically some exemplary aspects of the present disclosure, as implemented in the system shown in FIG. 1; and

FIG. 23 illustrates schematically some exemplary aspects of the present disclosure, as implemented in the system shown in FIG. 1.

### DESCRIPTION OF EMBODIMENTS

### Overview

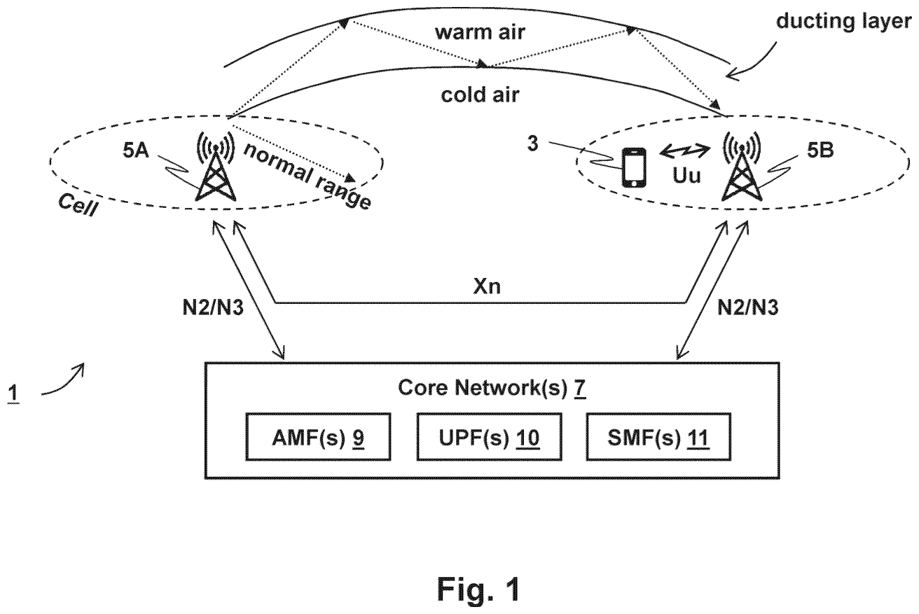

FIG. 1 illustrates schematically a mobile (cellular or wireless) telecommunication system 1 to which example embodiments of the disclosure may be applied.

In this system 1, users of mobile devices 3 (UEs) can communicate with each other and other users via base stations 5 (and other access network nodes) and a core network 7 using an appropriate 3GPP radio access technology (RAT), for example, an Evolved Universal Terrestrial Radio Access (E-UTRA) and/or 5G RAT. It will be appreciated that a number of base stations 5 form a (radio) access network or (R)AN. As those skilled in the art will appreciate, whilst one mobile device 3 and two base stations 5A/5B are shown in FIG. 1 for illustration purposes, the system, when implemented, will typically include other base stations/(R)AN nodes and mobile devices (UEs).

Each base station 5 controls one or more associated cells (either directly or via other nodes such as home base stations, relays, remote radio heads, distributed units, and/or the like). A base station 5 that supports Next Generation/5G protocols may be referred to as a ‘gNBs’. It will be appreciated that some base stations 5 may be configured to support both 4G and 5G, and/or any other 3GPP or non-3GPP communication protocols.

The mobile device 3 and its serving base station 5 are connected via an appropriate air interface (for example the so-called ‘NR’ air interface, the ‘Uu’ interface, and/or the like). Neighbouring base stations 5 are connected to each other via an appropriate base station to base station interface (such as the so-called ‘Xn’ interface, the ‘X2’ interface, and/or the like). The base stations 5 are also connected to the core network nodes via an appropriate interface (such as the so-called ‘NG-U’ interface (for user-plane), the so-called ‘NG-C’ interface (for control-plane), and/or the like).

The core network 7 (e.g. the EPC in case of LTE or the NGC in case of NR/5G) typically includes logical nodes (or ‘functions’) for supporting communication in the telecommunication system 1, and for subscriber management, mobility management, charging, security, call/session management (amongst others). For example, the core network 7 of a ‘Next Generation’/5G system will include user plane entities and control plane entities, such as one or more control plane functions (CPFs) 10 and one or more user plane functions (UPFs) 11. For example, the so-called Access and Mobility Management Function (AMF) 9 in 5G, or the Mobility Management Entity (MME) in 4G, is responsible for handling connection and mobility management tasks for the mobile devices 3. The so-called Session Management Function (SMF) is responsible for handling communication sessions for the mobile devices 3 such as session establishment, modification and release. The core network 7 may typically also include an Authentication Server Function (AUSF), a Unified Data Management (UDM) entity, a Policy Control Function (PCF), an Application Function (AF), amongst others. It will be appreciated that the nodes or functions may have different names in different systems. The core network 7 is coupled (via the UPF 11) to a Data Network (DN), such as the Internet or a similar Internet Protocol (IP) based network. The core network 7 may also be coupled to an Operations and Maintenance (OAM) function (not shown).

In this system 1, Cross Link Interference (CLI) may occur in the form of remote interference. Such remote interference occurs when atmospheric conditions allow propagation of radio waves from a transmitter (in this case base station 5A) to a remote location (in this case the location of base station 5B) where these radio waves can interfere with local transmissions. As shown in FIG. 1, remote interference may occur well beyond the normal transmission range of a base station (gNB), which is only a few kms. In this scenario, the following definitions may be used:
Aggressor gNB: a base station that transmits in the downlink and causes (or likely to cause) interference.
Victim gNB: a base station that receives in the uplink and that is affected by the interference.
gNB-gNB CLI: interference caused by downlink transmission from the aggressor gNB to the victim gNB performing uplink reception.
Victim UE: a UE performing uplink transmission to the victim gNB and being affected by gNB-gNB CLI.

In the example shown in FIG. 1, therefore, the first base station 5A is the aggressor, while the second base station 5B and the UE 3 are the victims of CLI.

In order to mitigate or alleviate the effects of such remote interference, the nodes of the system 1 are configured to perform one or more of the following procedures.

In a first procedure, the victim base station 5B identifies the aggressor base station 5A, from among a plurality of potential aggressors, based on respective CLI related configuration information for each potential aggressor.

In a second procedure, the aggressor base station 5A transmits at least one reference signal for measuring CLI caused, outside a serving area of the aggressor base station 5A, by the radio transmissions from the aggressor base station 5A.

In a third procedure, the base stations 5A and 5B configure at least one resource for measurement of CLI outside the serving area of a transmitter of the aggressor base station 5A. The level of the CLI is determined based on a received signal strength value of a CLI reference signal from the transmitter of the aggressor base station 5A over the at least one resource.

In a fourth procedure, the victim base station 5B detects, based on an associated reference signal, occurrence of CLI caused outside the serving area (cell) of the aggressor base station 5A. The victim base station 5B transmits information indicating the occurrence of the CLI to a node responsible for CLI management (which may be another base station or the OAM function).

In a fifth procedure, the UE 3 and the aggressor base station 5A are configured to transmit such that the arrival time of an uplink signal from the UE 3 at the victim base station 5B and the arrival time of a CLI reference signal from the aggressor base station 5A are aligned.

Beneficially, using one or more of the following procedures, the nodes of this system 1 are able to mitigate or alleviate harmful remote interference.

### User Equipment (UE)

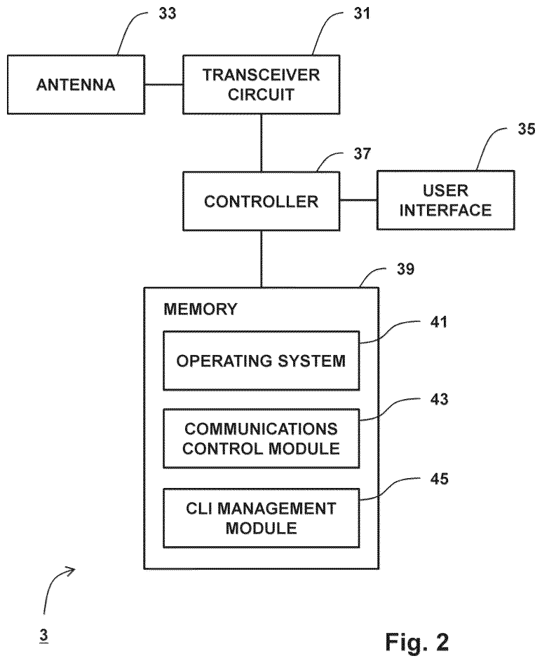

FIG. 2 is a block diagram illustrating the main components of the mobile device (UE) 3 shown in FIG. 1. As shown, the UE 3 includes a transceiver circuit 31 which is operable to transmit signals to and to receive signals from at least one connected node via one or more antennas 33. Although not necessarily shown in FIG. 2, the UE 3 will of course have all the usual functionality of a conventional mobile device (such as a user interface 35) and this may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication network 1 or from a removable data storage device (RMD), for example. The software includes, among other things, an operating system 41, a communications control module 43, and an interference (e.g. CLI) management module 45.

The communications control module 43 is responsible for handling (generating/sending/receiving) signalling messages and uplink/downlink data packets between the UE 3 and other nodes, including (R)AN nodes 5 and core network nodes. The signalling may comprise control signalling related to CLI management such as configuration of resources for CLI reference signals and measurements. The communications control module 43 is also responsible for determining and applying the appropriate TDD and/or FDD configuration.

The interference/CLI management module 45 is responsible for CLI management such as receiving and applying associated reference signal configurations (via the communications control module 43).

### Access Network Node (Base Station)

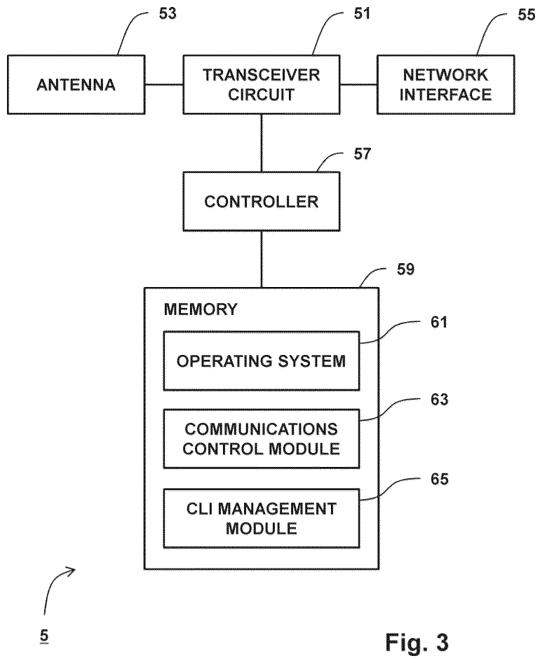

FIG. 3 is a block diagram illustrating the main components of the base station 5 (or a similar access network node) shown in FIG. 1. As shown, the base station 5 includes a transceiver circuit 51 which is operable to transmit signals to and to receive signals from at least one connected UE 3 via one or more antennas 53 and to transmit signals to and to receive signals from other network nodes (either directly or indirectly) via a network interface 55. The network interface 55 typically includes an appropriate base station—base station interface (such as X2/Xn) and an appropriate base station—core network interface (such as S1/N1/N2/N3). A controller 57 controls the operation of the base station 5 in accordance with software stored in a memory 59. The software may be pre-installed in the memory 59 and/or may be downloaded via the telecommunication network 1 or from a removable data storage device (RMD), for example. The software includes, among other things, an operating system 61, a communications control module 63, and an interference (e.g. CLI) management module 65.

The communications control module 63 is responsible for handling (generating/sending/receiving) signalling between the base station 5 and other nodes, such as the UE 3 and the core network nodes. The signalling may comprise control signalling related to CLI management such as configuration of resources for CLI reference signals and measurements. The communications control module 63 is also responsible for controlling and applying the appropriate TDD and/or FDD configuration.

The interference/CLI management module 65 is responsible for CLI management in the radio access network portion to which the access network node belongs and for exchanging CLI related assistance information with other access network nodes (either directly or via the core network 7).

### Core Network Function

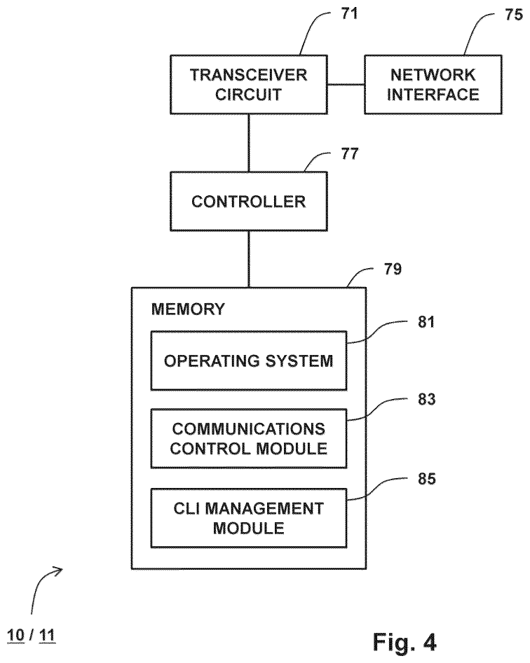

FIG. 4 is a block diagram illustrating the main components of a generic core network function, such as the CPF 10 or the UPF 11 shown in FIG. 1. As shown, the core network function includes a transceiver circuit 71 which is operable to transmit signals to and to receive signals from other nodes (including the UE 3, the base station 5, and other core network nodes) via a network interface 75. A controller 77 controls the operation of the core network function in accordance with software stored in a memory 79. The software may be pre-installed in the memory 79 and/or may be downloaded via the telecommunication network 1 or from a removable data storage device (RMD), for example. The software includes, among other things, an operating system 81, and a communications control module 83, and an interference (e.g. CLI) management module 85.

The communications control module 83 is responsible for handling (generating/sending/receiving) signaling between the core network function and other nodes, such as the UE 3, the base station 5, and other core network nodes. The signalling may comprise control signalling related to CLI management such as configuration of resources for CLI reference signals and measurements.

The interference/CLI management module 85 is responsible for assisting CLI management in the radio access network portion served by the core network node.

### DETAILED DESCRIPTION

In the present disclosure the following definitions are used.
Aggressor gNB: a base station (gNB) that transmits in the DL
Victim gNB: a base station (gNB) that receives in the UL
gNB-gNB CLI: interference caused by DL transmission from the aggressor gNB to the victim gNB performing UL reception
Victim UE: a UE performing UL transmission to the victim gNB and being affected by gNB-gNB CLI

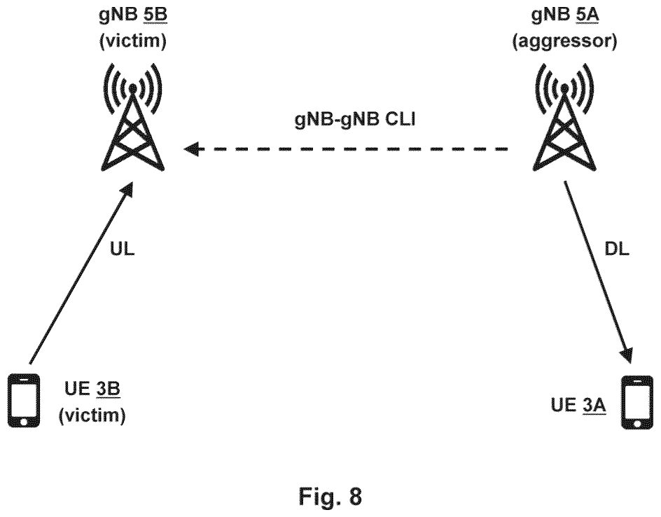

The above nodes and the relationships between them are illustrated schematically in FIG. 8.

### How to Identify the Aggressor?

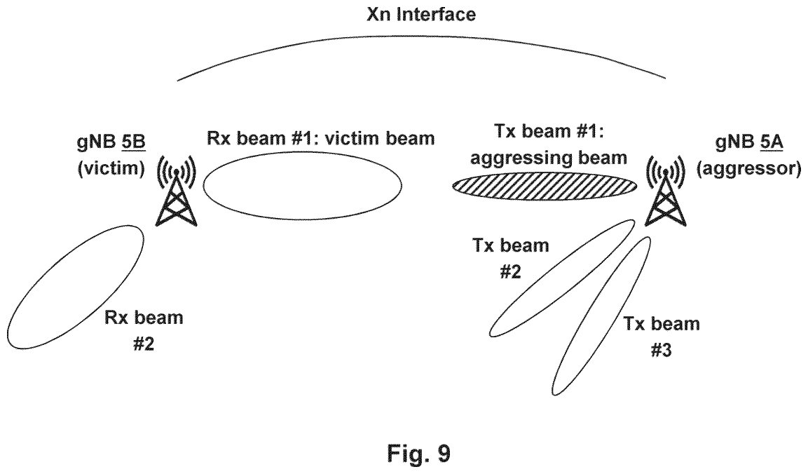

FIG. 9 illustrates schematically an exemplary scenario in which an aggressor base station 5A (denoted ‘gNB 5A’) causes CLI to a victim base station 5B (denoted ‘gNB 5B’). Specifically, transmitter (Tx) beam #1 of base station 5A causes interference to receiver (Rx) beam #1 of base station 5B.

In this scenario, a victim base station 5B needs to identify the source of the interference (in this example, base station 5A) to mitigate the interference from that particular aggressor. In case of beamforming, not only the aggressor node, e.g. gNB 5A, should be identified, but the aggressing beam as well, for example Tx beam #1 of gNB 5A, as shown in FIG. 9. Once the aggressor base station/beam has been identified, the interference can be mitigated, for example, by not scheduling UEs 3 covered by the aggressing beam during one or more particular symbols/slots corresponding to the period during which the aggressor base station 5A transmits in the downlink, or more specifically, the period during which the signals transmitted by the aggressor base station 5A arrive at the cell of the victim base station 5B (with a delay tha depends on the distance between the two base stations 5A and 5B).

Since in case of remote interference the aggressor and victim nodes may be located at a relatively large distance from each other, they are not considered to be neighbours for normal network operation such as mobility, load balancing, dual connectivity, and/or the like.

In this example, the base stations 5 have a base station to base station interface between them (e.g. an Xn interface and/or the like). Beneficially, the base stations 5A and 5B may be configured to exchange, over the Xn interface (or other base station to base station interface) appropriate information to assist the other base station in mitigating CLI. Specifically, the base stations 5 (at least the aggressor 5A) may be configured to transmit, to the other base station 5, configuration information that may be relevant for CLI management (including TDD configuration, beam configuration, reference signal configuration, and/or the like). The base stations 5 may exchange this information once (e.g. upon establishment or a connection between them) or on a regular basis (on demand, periodically, or upon a change in their configuration) to assist each other's dynamic TDD operation.

It will be appreciated that if a direct base station to base station interface (e.g. Xn interface) is not available for information exchange, RRC containers may be used to exchange the relevant information between two base stations via Ng interface and/or the like. For example, the aggressor base station 5A may send this information to the core network 7 (via the Ng-interface, using one or more appropriate RRC container) and the core network 7 may forward the information (at least one RRC container) to one or more other base stations 5B, which may be one or more victims of CLI cause by transmissions from the base station 5A.

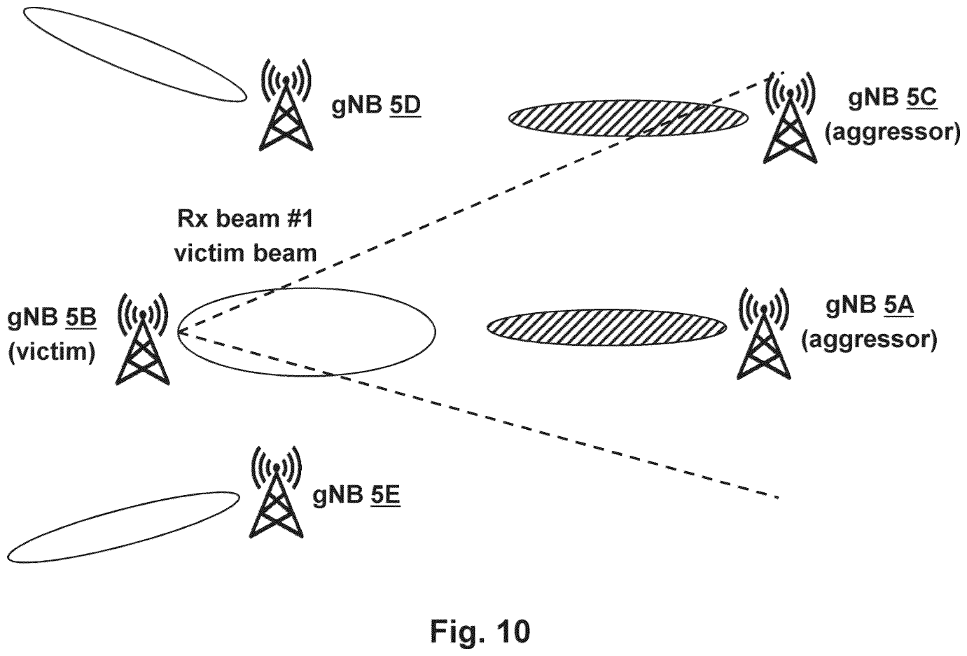

FIG. 10 illustrates schematically an exemplary procedure for identifying an aggressor base station (denoted ‘gNB 5A’) by a victim base station (denoted ‘gNB 5B’), using the above describe approach. In this case, the base stations 5 exchange appropriate assistance information over the base station to base station interface between them (e.g. Xn and/or the like).

In this example, there are five base stations 5, among which gNB 5B is the victim base station and gNB 5A is the aggressor. Rx beam #1 of gNB 5B suffers CLI from (a beam of) gNB 5A.

In this approach, the victim base station 5B identifies the aggressor 5A based on the applicable TDD configuration, beam configuration and gNB position information exchanged via the base station to base station interface (or via the core network 7). In other words, at least some of the base stations shown in FIG. 10 are configured to support such information exchange for assisting CLI management.

The procedure includes the following steps.

Step 1: The victim base station 5B exchanges TDD configuration info with surrounding base stations 5, so that with such information it knows which at least one base station 5 perform DL transmission when it performs UL reception in one or more particular symbols/slots. A list of potential aggressors is created accordingly.

The exchanged information may include, for example, common or dedicated uplink/downlink configuration (which may be included in the so-called tdd-UL-DL-ConfigurationCommon and tdd-UL-DL-ConfigurationDedicated information elements, respectively), a downlink control information (DCI) format (e.g. DCI format 2_0), and any additional parameter related to sub-band non-overlapping full duplex operation, such as one or more symbols/slots/frequency bands used for UL and/or DL.

The exact type of information to be exchanged and how frequent the information exchange should be may depend on capability of the interface used between the base stations 5. It will be appreciated that a subset of the above-mentioned parameters may be exchanged.

In this example, after step 1, the victim base station 5B may be able to narrow down the potential aggressors to an initial set (or list) of potential aggressor nodes including base stations 5A, 5C, 5D, and 5E that have exchanged their associated TDD (or CLI) related information with the victim base station 5B (and based on the exchanged information).

Step 2: The victim base station 5B, based on the other base stations' location, based on its own location and information related to its Rx beam (e.g. beam direction, beam width, etc.), may further derive potential aggressors to reduce the size of the initial list. In this example, after step 2, the victim base station 5B may be able to narrow down the initial set (list) of potential aggressor nodes to base stations 5A and 5C (i.e. remove base stations 5D and 5E from the list of potential aggressors).

Step 3: The victim base station 5B and its surrounding base stations 5 exchange their transmit beam configuration information (e.g. beam direction, beam width, configuration of associated reference signals, such as NZP-CSI-RS, SSB, etc.). It will be appreciated that this information may be exchanged as part of the information exchanged in step 2. Based on this information, the victim base station 5B may be able to identify one or more potential aggressing beams. In this example, the victim base station 5B may be able to narrow down the potential aggressor to base station 5A and a specific beam of that base station 5A.

Step 4 (optional): Each base station 5 may be configured to share its aggressor list and/or aggressor beam list with a centralized controller. The centralized controller may be, for example, an operations administration and maintenance (OAM) function, or one of the base stations, depending on whether centralized or distributed CLI management mechanism is employed. Alternatively, the victim base station 5B may indicate to the centralized controller that it is experiencing CLI and the centralized controller may perform steps 1 to 3 to derive a list of aggressor nodes and/or beams for the victim base station 5B (at least one aggressor node and/or beam) and send this list to the victim base station 5B.

It will be appreciated that there might be more than one aggressor (and/or more than one beam or cell may suffer CLI) in which case the procedure may be applied to each aggressor or beam/cell separately. Alternatively, a single procedure may identify more than one aggressor or beam, if appropriate.

It will also be appreciated that the process may stop at any step during steps 1-3, providing a different level or granularity of identification of the aggressor. Accordingly, the following alternatives are envisaged:
Alternative 1: by performing step 1 only, an aggressor gNB list {5A,5C,5D,5E} is available.
Alternative 2: by performing steps 1 and 2, a more specific aggressor gNB list {5A,5C} with reduced size is available.
Alternative 3: by performing steps 1, 2, and 3, the aggressor gNB list {gNB 5A} with further reduced size is available (or a specific aggressor, as in this example).

Beneficially, the victim base station 5B is able to identify the aggressor node (at least a list of potential aggressor nodes) based on the available information and take appropriate actions to mitigate the CLI caused by one or more aggressor nodes.

In order to ensure effective CLI management, the aggressor gNB/beam list may need to be updated. It may be updated on-demand (e.g. when CLI is detected again), exchanged when the TDD/beam configuration of one of the base stations changes, or periodically (e.g. based on an associated timer), depending on Xn interface capability.

It will also be appreciated that, once the aggressor base station 5A has been identified, the aggressor base station 5A may indicate its transmission power to the victim base station 5B. Alternatively, transmission power information may be provided by each potential aggressor node, and this information may be used in any of steps 1 to 3.

The transmission power information may be used by the victim base station 5B to determine whether the (potential) aggressor base station's transmissions will interfere with the victim base station 5B.

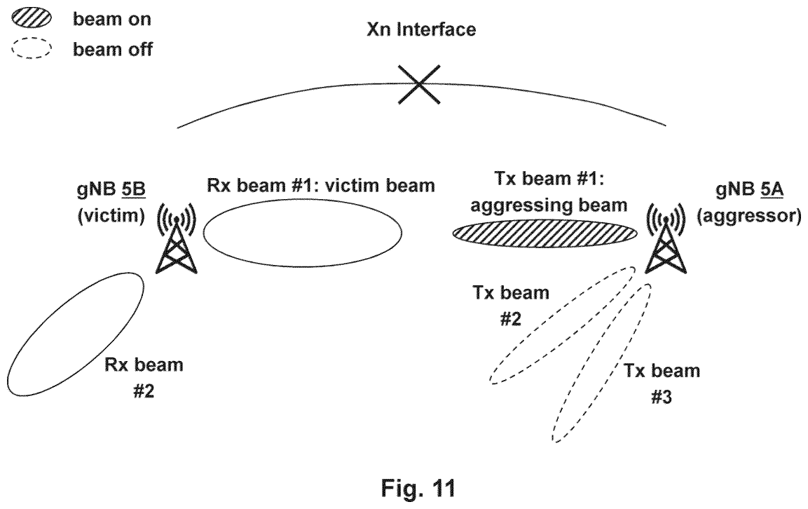

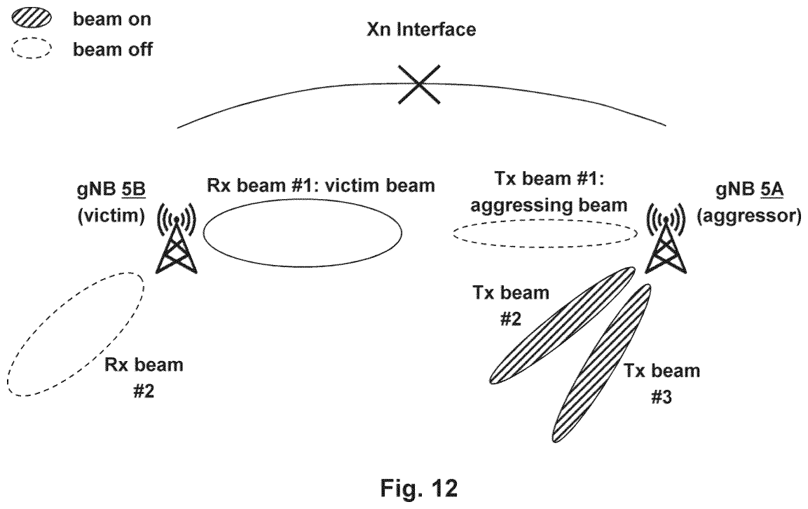

FIGS. 11 and 12 illustrate schematically another exemplary procedure for identifying an aggressor base station, without having (or using) a base station to base station interface between the base stations. In this case, beam sweeping (FIG. 11) or nulling beam sweeping (FIG. 12) is used to identify the aggressor.

In more detail, one or more aggressor nodes may be identified based on the associated TDD configuration and position information (exchanged via the Xn interface) even without exchanging (or a capability to exchange) beam information between the base stations 5.

In this scenario, steps 1 and 2 may be the same as described above with reference to FIG. 10.

However, in step 3, each potential aggressor base station 5 performs a beam sweeping or a nulling beam sweeping operation to help the victim base station 5B measure the CLI level (or a change of CLI level) which may be used in identifying which beams cause CLI to that particular victim base station 5B. The measured CLI level (or change of CLI level) may be reported to the relevant potential aggressor node. Based on the report, the potential aggressor nodes (gNBs) can determine whether they are aggressors to another node, and identify which Tx beam is an aggressor beam (or aggressor beams, if more than one).

In case of beam sweeping, the (aggressor) base station 5A turns on its beams one by one (in other words, schedules downlink communications via different beams, in turn) and the victim base station 5B reports the measured CLI level to the base station 5A. Based on the report, the base station 5A can identify the beam causing a high level of CLI (e.g. CLI above an associated threshold).

In case of nulling beam sweeping, the (aggressor) base station 5A turns off its beams one by one (in other words, it does not schedule any downlink communications via different beams, in turn) and the victim base station 5B reports the measured change of CLI level to the base station 5A. In this case, the aggressing beam will cause the largest change in CLI level. Based on the report, the base station 5A can identify the aggressor beam.

It will be appreciated that beam sweeping may be performed either in a proactive or a passive manner. If proactive beam sweeping is used, the aggressor base station 5A may proactively configure appropriate reference signals for beam sweeping (e.g. CSI-RS/SSB reference signals, which will be discussed later) in which case the beams may not necessarily be the beams used for actual data transmission in the cell of the base station 5A. This approach may beneficially reduce the disruption caused to the base station's 5A transmissions by the beam sweeping operation. Moreover, it can be used to identify additional potential aggressing beams (which would cause CLI to another base station in the future). For each Tx beam, the victim base station 5B reports the respective measurement results to the base station 5A.

If passive beam sweeping is used, then the aggressor base station 5A only performs beam sweeping for the beams currently being used (or expected to be used soon). For the beams currently used, demodulation reference signal (DMRS), or even data, may be used for CLI measurement by the victim base station 5B. For other beams, CSI-RS/SSB may be used. For each Tx beam, the victim base station 5B reports the respective measurement results to the base station 5A.

The nulling beam sweeping scheme may only be applied to the beams currently used for data transmission.

### What to Measure?

It will be appreciated that any of the following approaches may be used for CLI management:
Alt 1: measure reference signals, e.g. Channel State Information-Reference Signal (CSI-RS), Synchronization Signal Block (SSB), demodulation reference signal (DMRS): in this case, the applicable reference signal configuration needs to be exchanged between base stations;
Alt 2: measure data transmission from aggressors; and
Alt 3: perform blind measurement.

In order to support CLI specific measurements, the following measurement abilities are proposed for the base stations 5:
measurement of CLI CSI-RS RSRP (for Alt 1); and
measurement of gNB CLI-RSSI (for Alt 2).

In case of Alt 1, the CLI CSI reference signal received power (CLI CSI-RSRP) is defined as the linear average over the power contributions (in [W]) of the resource elements of one or more antenna ports that carry CSI reference signals indicated for CLI RSRP measurements within the considered measurement frequency bandwidth in the indicated CSI-RS occasions.

For CSI CSI-RSRP determination CSI reference signals transmitted on which antenna port shall be indicated and the base station 5 is expected to be capable of measuring one or more CLI CSI-RS resources outside of the active downlink bandwidth part.

In more detail, the reference point for the CLI CSI-RSRP shall be:
for type 1-C base station: the Rx antenna connector,
for type 1-0 or 2-0 base station: based on the combined signal from antenna elements corresponding to a given receiver branch,
for type 1-H base station: the Rx Transceiver Array Boundary connector.

In the above listing, type 1-C, type 1-0, type 2-0, and type 1-H base station correspond to the respective definitions given in 3GPP TS 38.104.

For frequency range 1 and 2, if receiver diversity is in use by the base station 5, the reported CLI CSI-RSRP value shall not be lower than the corresponding CLI CSI-RSRP of any of the individual receiver branches.

It should be noted that Alt 1 can be extended to other reference signals, such as SSB, DMRS, etc., depending on base station's choice.

Turning now to Alt 2, the gNB specific CLI Received Signal Strength Indicator (CLI-RSSI) is defined as the linear average of the total received power (in [W]) observed only in the indicated OFDM symbols of one or more indicated measurement time resources, in the indicated measurement bandwidth from all sources, including co-channel serving and non-serving cells, adjacent channel interference, self-interference, thermal noise, etc.

The base station 5 is expected to be capable of measuring one or more resources outside of the active downlink bandwidth part.

The reference point for the gNB CLI RSSI shall be:
for type 1-C base station: the Rx antenna connector,
for type 1-0 or 2-0 base station: based on the combined signal from antenna elements corresponding to a given receiver branch,
for type 1-H base station: the Rx Transceiver Array Boundary connector.

For frequency range 1 and 2, if receiver diversity is in use by the base station 5, the reported gNB CLI RSSI value shall not be lower than the corresponding gNB CLI RSSI of any of the individual receiver branches.

### When to Measure?

Regarding the issues of when to trigger the measurement of CLI, two main cases may be distinguished, along with some associated solutions.

Case 1: if so-called perfect Xn interface is used between the base stations, both the victim base station 5B and the aggressor base station 5A have knowledge of when and where CLI will happen based on the TDD related configuration information exchanged between them. In this case, the following solutions may be used.

Solution 1: UE UL transmission is allowed when gNB-gNB CLI happens because the CLI level may not be high enough to affect the UL transmission. CLI measurement may be performed during UL transmission from the first symbol/slot where gNB CLI happens.

Solution 2: UE UL transmission is not allowed when gNB-gNB CLI measurement is performed and the victim base station 5B may need to perform CLI measurement before UL transmission.

Case 2: if a non-perfect Xn interface is used between the base stations, the victim base station 5B and the aggressor base station 5A may not have sufficient knowledge of when and where CLI may happen as they may not have exchanged all (or any) TDD related configuration information.

Solution: in this case, CLI measurement may be performed when the performance of UL transmission is affected, which can be indicated by e.g. a higher associated block error rate (BLER) value or a lower associated signal-to-interference-plus-noise ratio (SINR) value.

Another solution (for either Case 1 or Case 2) is to allow the victim base station 5B to periodically measure CLI without associated triggering. Alternatively, all solutions may be combined flexibly.

For both cases, a parameter T_{delta} (T_{Δ}) may be defined and configured to indicate the time difference between the time of CLI measurement and the time of CLI mitigation is expected to be applied. This parameter may be signalled to the UE 3 so that the UE 3 knows when CLI can be mitigated.

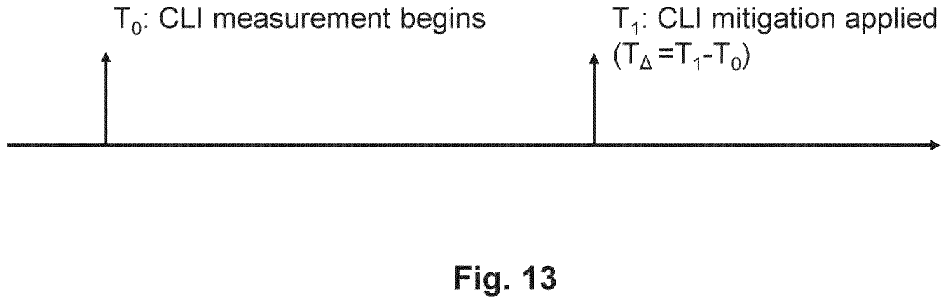

FIG. 13 illustrates schematically an exemplary way of defining T_{Δ} based on a value (T₀) representing the time when CLI measurement begins and another value (T₁) representing the time when CLI mitigation is applied.

It should be noted that the Xn-interface operation mentioned above can also be applied to Ng-interface when Xn-interface is not available.

### How to Measure?

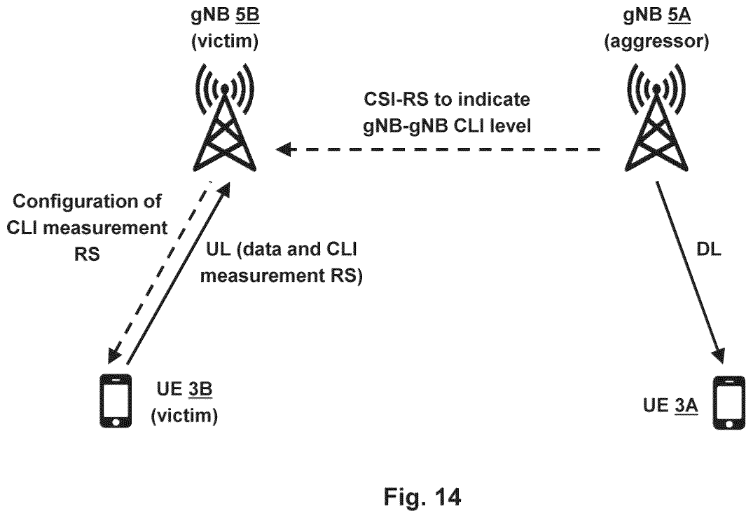

FIG. 14 illustrates schematically an exemplary approach for performing measurements for mitigating CLI in the system shown in FIG. 1. In this case, the following definitions apply (in addition to those given with reference to FIG. 8).
Aggressor gNB: a base station (gNB) that configures and transmits non-zero power (NZP) reference signals, e.g., CSI-RS, DMRS, SSB, etc., to indicate gNB-gNB CLI level
Victim gNB: a base station (gNB) that configures one or more time-frequency resources as CLI measurement reference signals/resources and receives and measures the received signal strength, e.g., CSI-RS from aggressor gNB, on those resources
gNB-gNB CLI: the signal strength of an NZP RS from the aggressor gNB which indicates the interference level of gNB-gNB CLI.
Victim UE: a UE configured by the victim gNB with a set of one or more time-frequency resources for CLI measurement

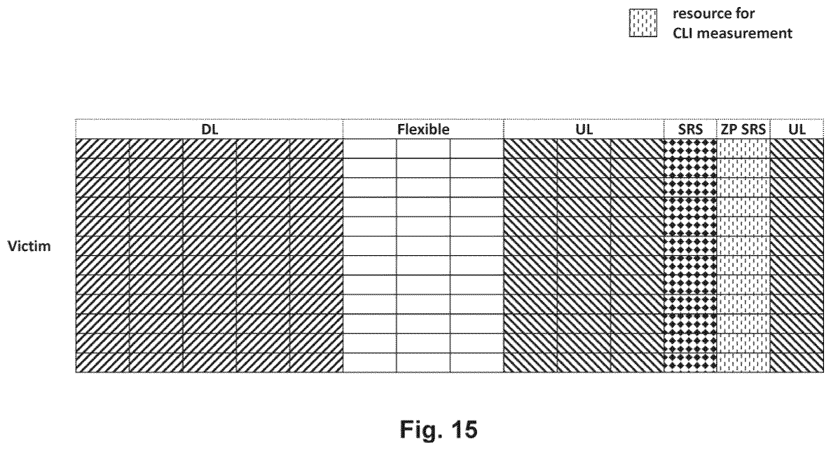

Further details of the issue of how to measure CLI will be given with reference to FIGS. 15 to 17.

FIG. 15 shows a first alternative. In this case, a new RS type, e.g., zero power (ZP) SRS is configured for the victim UE 3. The victim base station 5B measures CLI in one or more ZP SRS resources. It will be appreciated that the ZP SRS may be configured following similar (or the same) configuration rules as SRS, one or more resources/resource sets for one or more beams/gNBs. In the example shown in FIG. 15, the ZP SRS (for CLI) is configured over one or more symbols following the regular SRS symbols. It will be appreciated that the number of ZP SRS may be up to n_max OFDM symbols, where n_max is an integer having a value of 12 or less.

The comb factor of ZP SRS may be selected from a set {1, 2, 4, 8, 16} depending on the maximum number of aggressors (e.g. comb factor 1 in FIG. 15). Accordingly, the number of aggressors that can be measured is given by n_max*comb_factor*n_code, where n_code is the number of orthogonal codes in the code domain.

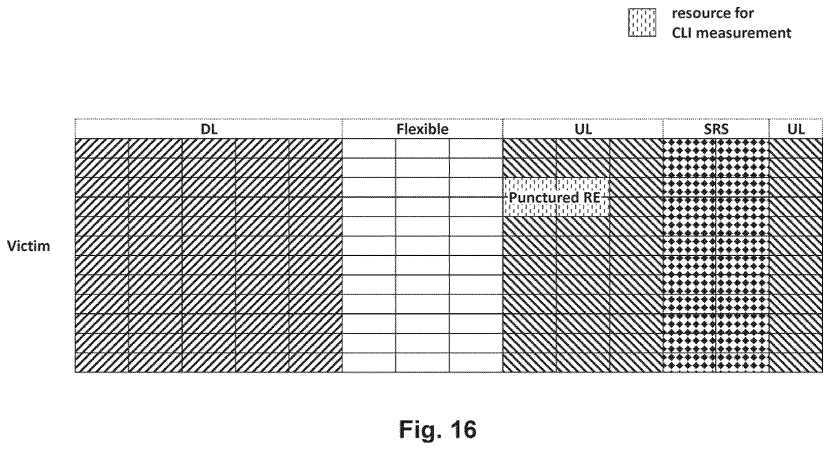

FIG. 16 shows a second alternative. In this case, an appropriate (CLI specific) puncturing pattern is configured for the victim UE 3. The UL data and/or SRS may be punctured for time and frequency resources indicated in the associated pattern configuration. It will be appreciated that if data is punctured, the actual coding rate for UL becomes higher.

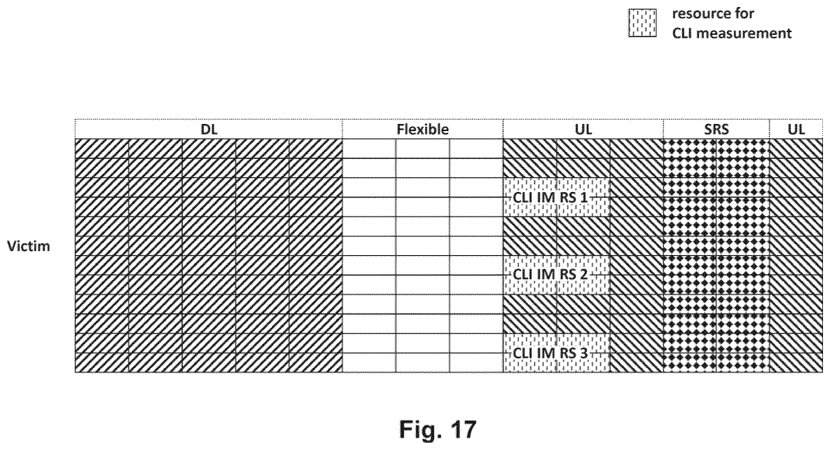

FIG. 17 shows a third alternative. In this case, a ZP CLI management RS is configured for the victim UE 3. Compared to the second alternative above, the actual coding rate and UL channel sounding performance will not change.

It will be appreciated that multiple resources and resource sets may be configured per base station 5. Each resource may correspond to a respective aggressor beam, e.g., CLI IM RS #1 for Tx beam #1 of the aggressor base station 5A, CLI IM RS #2 for Tx beam #2 of the (same) aggressor base station 5A, and CLI IM RS #3 for Tx beam 3. Each resource set may correspond to a particular aggressor base station 5A, e.g., CLI IM RS #1, #2, and #3 may belong to the same resource set which corresponds to one aggressor base station 5A.

In a fourth alternative, ZP CSI-RS resources may be configured. These resources may be configured to the UEs 3 served by the victim base station 5B for rate matching/puncturing when CSI-RS type resource configuration is used for CLI.

Compared to the configuration of ZP CSI-RS resources for DL rate matching/puncturing, as currently supported in NR, in this system 1 the resources may also be used for UL rate matching/puncturing. Similarly to the DCI based indication for the Physical Downlink Shared Channel (PDSCH), the DCI for the Physical Uplink Shared Channel (PUSCH) may also be adapted to indicate which ZP CSI-RS resource to activate.

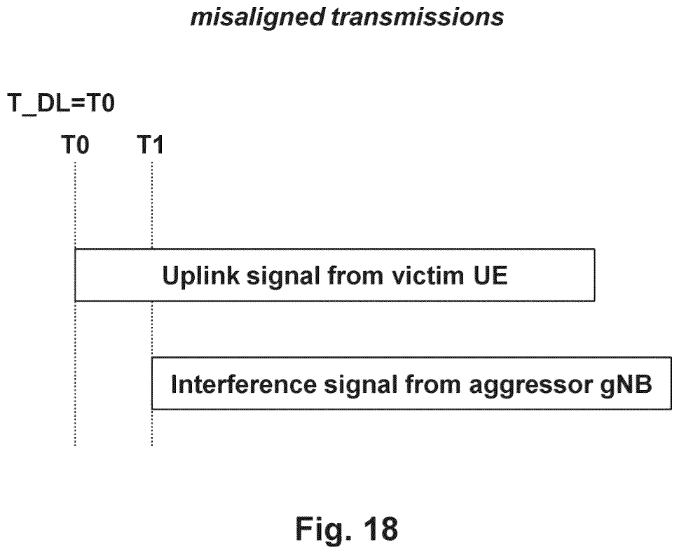

FIG. 18 illustrates schematically a potential timing issue in case of CLI, i.e. the issue of misaligned transmissions by the aggressor and the victim (in this case UE).

As can be seen, the arrival time of an UL signal from a victim UE 3 and the arrival time of an interference signal from the aggressor base station 5A may not be aligned due to the distance between them. The UL signal from the victim UE 3 arrives at time T0 and the interference signal from the aggressor arrives at time T1 (at the victim base station 5B).

The timing difference T_{Δ1}=T1−T0 depends on the propagation delay and might be larger than the duration of the applicable cyclic prefix (CP) so that the measurement of CLI may be affected. In FIG. 18, the following definitions apply:
T0: arrival timing of an UL signal from the victim UE 3
T1: arrival timing of an interference signal from the aggressor node (gNB 5A)

In this example, DL transmission of the entire network 1 is synchronized. In other words, T_DL indicates the DL timing of both base stations 5A and 5B. T_DL can be assumed to be (substantially) equal or close to T0 since it might also include UL/DL or Tx/Rx transition time.

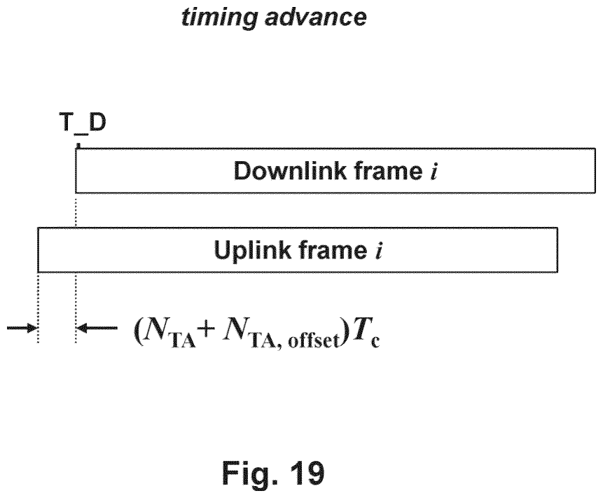

The UE 3 is configured with an associated timing advance (TA) value [in ms], which is given by the following formula: TA=N_{TA}+N_{TA,offset}. Accordingly, the UE 3 transmits TA ms earlier than T0, as shown in FIG. 19.

In order to assist efficient CLI management, the following solutions are proposed:
Alt1: The aggressor base station 5A transmits its own reference signal T_{Δ2}=T0−T3 [ms] earlier than T0 (where T0 represents the applicable DL timing of the victim base station 5B). For synchronized networks, T_DL applies to both the aggressor base station 5A and the victim base station 5B. T_DL can be assumed to be (substantially) equal or close to T0 since it might also include UL/DL or Tx/Rx transition time.

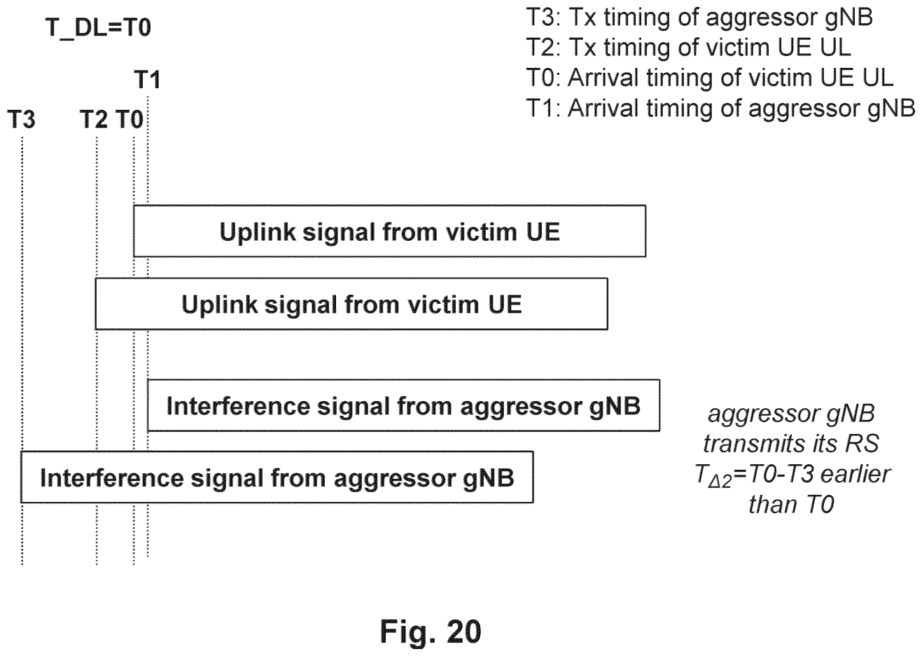

An example of this solution is shown in FIG. 20.

In this case, T_{Δ2} is less than or equal to the value given by the distance between the aggressor base station 5A and the victim base station 5B divided by ‘c’ (the speed of light, or in this case, the speed of radio waves). Thus, the arrival times of UL signal from victim UE and the interference signal from the aggressor base station 5A are aligned. In this context, the term aligned means that T_{Δ1}=T1−T0 is smaller than the duration of the CP used in the cell of the victim base station 5B.

There is no need to change the operation of the UE 3. Thus, Alt1 may be up to base station (gNB) implementation.

Alt2: in this case, the aggressor base station 5A does not transmit its own reference signal earlier since it might affect its own DL transmission timing. However, the victim UE 3 is configured to delay its transmission by an amount (denoted T_{Δ3}) that will result in alignment between the UE's UL transmission and the downlink signal from the aggressor base station 5A.

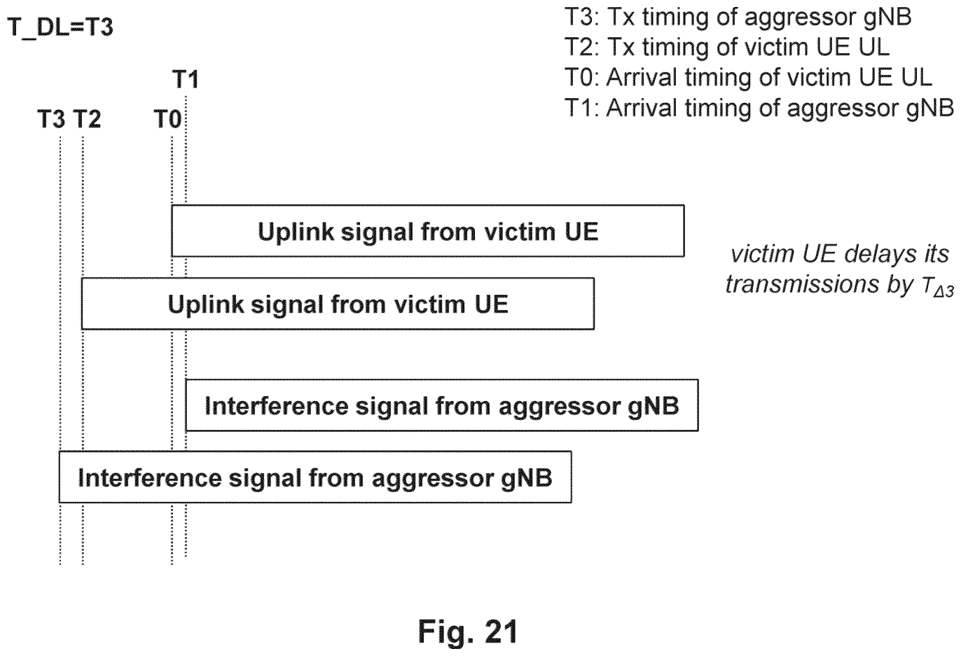

An example of this solution is shown in FIG. 21, where T_DL=T3 represents the DL timing of both the aggressor base station 5A and the victim base station 5B (assuming a synchronized network).

T_{Δ3} is configured such that the arrival times of the UL signal from the victim UE 3 and the interference signal from the aggressor base station 5A are aligned (i.e. T_{Δ1}=T1−T0 is smaller than the duration of the CP used in the cell of the victim base station 5B). It will be appreciated that T_{Δ3} may be absorbed into the UE's timing advance (TA) value. In this case, a negative TA value may be necessary.

Since in Alt2 the UL transmission of the victim UE 3 is delayed, it may result in the UE's own UL/DL no longer being aligned. This issue may be addressed by introducing an additional GP (between UL and DL resources).

### Measurement Reporting

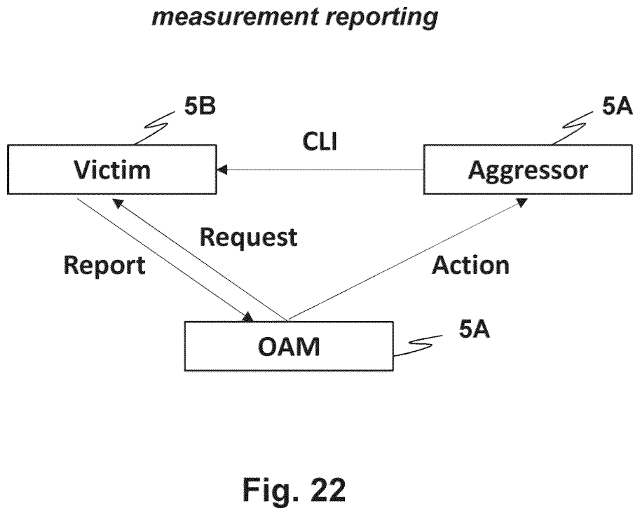

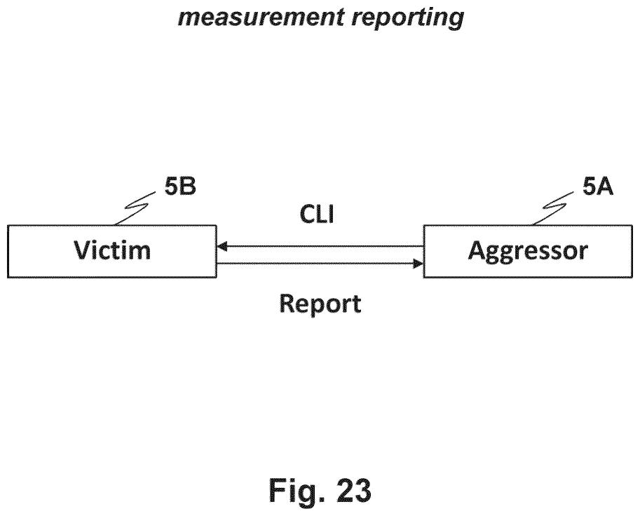

The following is a discussion of some exemplary ways in which measurement results may be reported for taking appropriate CLI management actions, with reference to FIGS. 22 and 23.

Alt1 (FIG. 22): for centralized CLI management, report measurement results to a centralized controller (e.g. OAM).

Alt2 (FIG. 23): for distributed CLI management, report measurement results to the aggressor node (e.g. via Xn interface).

The reporting may be periodic, semi-persistent, and/or aperiodic (on-demand).

In case of semi-persistent and aperiodic on-demand reporting, reporting may take place based on (in response to) a request from the OAM or the aggressor. Reporting may also be initiated by the victim base station 5B when the detected/measured interference is above an associated threshold. The threshold may either be pre-defined or configured based on the received signal power in UL.

### CLI-RS Resource Configuration

The following is a description of some exemplary ways in which the CLI specific reference signal (CLI-RS) may be configured and a description of when to transmit the CLI-RS.

The CLI-RS resource may have a persistent/semi-persistent periodicity or it may be an aperiodic CLI-RS resource.

In case of persistently allocated resources, a cell specific legacy RS (such as CSI-RS or SSB) may be used for measurement.

In case of semi-persistent/aperiodic resources, the base stations 5 may exchange information regarding the time occasion of their RS transmissions. This exchange may be triggered for example when a TDD conflict is identified by one of the base stations 5.

In one alternative, the victim base station 5B may request the aggressor base station 5A to transmit CLI-RS and the aggressor base station 5A may indicate the applicable resource reservation and transmit the CLI-RS accordingly.

In another alternative, the aggressor base station 5A transmits its CLI-RS and provides information regarding the used CLI-RS resource configuration to the victim base station 5B (on its own, i.e. without a request from the victim base station 5B).

Regarding the issue of when to transmit the CLI-RS, the time resources for the CLI-RS may be defined on a slots/symbol level. The slots/symbol type to be used for CLI-RS transmission may be selected such that:
1) The victim base station 5B is able to measure and receive the RS. It means that CLI-RS transmission should occur during victim UL slots/symbols or when no transmission is being performed by the victim base station 5B.
2) The CLI-RS transmission occurs during a DL slot or when no transmission is present so that DL RS does not interfere with UL receptions.

In accordance with point 2 above, the RS should be transmitted as follows:
Option-1: transmit CSI-RS on the aggressor base station's one or more DL slots/symbols overlapping with the victim base station's one or more UL slots/symbols (this would mean that CLI-RS will be transmitted only on the conflicted slots).
Option-2: transmit CSI-RS on the victim base station's one or more UL slots/symbols overlapping with any flexible slot of the aggressor base station.
Option-3: transmit CSI-RS on the aggressor base station's DL slot/symbol overlapping with the flexible slots of the victim base station.
Option-4: transmit CSI-RS on the overlapping flexible slots of both the victim base station and the aggressor base station.

In order to realise options 2 to 4, the base stations may need to share information about their flexible time occasions with each other.

The type of CLI-RS resource to be used may also depend on the respective slot/symbol type of the aggressor base station and victim base station. For example, if an UL slot/symbol of the victim base station is used for CLI-RS transmission, then SRS type resource configuration may be used. Otherwise CSI-RS type resource configuration may be used.

It will be appreciated that additional restrictions may apply for CLI-RS transmission so that the CLI-RS is transmitted at least a certain duration before the start of a conflicted slot. Such additional restriction regarding CLI-RS timing may be realised using a fixed value (e.g. defined in the relevant 3GPP specifications) or a value decided by the victim base station and indicated to the aggressor base station.

If the CSI-RS is transmitted to avoid conflict in DL+UL slots, then the CLI-RS can be transmitted only on the frequency resources and beams where conflict is expected to occur (i.e. DL on aggressor base station and UL on victim base station). It will be appreciated that this information (i.e. frequency resources/beams information) may need to be exchanged between the base stations.

### Modifications and Alternatives

Detailed example embodiments have been described above. As those skilled in the art will appreciate, a number of modifications and alternatives can be made to the above example embodiments whilst still benefiting from the disclosure embodied therein.

It will be appreciated, for example, that whilst cellular communication generation (2G, 3G, 4G, 5G, 6G etc.) specific terminology may be used, in the interests of clarity, to refer to specific communication entities, the technical features described for a given entity are not limited to devices of that specific communication generation. The technical features may be implemented in any functionally equivalent communication entity regardless of any differences in the terminology used to refer to them.

It will be appreciated that the CLI-RS or puncturing pattern may be configured within one or multiple subbands if a sub-band full Duplex (SBFD) operation is employed. The CLI-RS or puncturing pattern may be configured in a periodic, semi-persistent, or dynamic manner. In case of periodic and semi-persistent configuration, Radio Resource Control (RRC) signalling (e.g. one or more appropriately formatted information element) may be used for configuration of the CLI-RS or puncturing pattern, and Medium Access Control (MAC) signalling (e.g. a MAC control element) may be used for activation/deactivation of the CLI-RS or puncturing pattern. In case of dynamic configuration, an appropriately formatted Downlink Control Information (DCI) may be used for configuration/activation/deactivation or RRC may be used for configuration and DCI for activation/deactivation.

The type of CLI-RS or puncturing resource may be dependent on the CLI-RS resource configuration type. For example, if CLI-RS resource configuration is of type SRS, then the above described first alternative (ZP SRS, FIG. 15) may be used otherwise if CLI-RS resource configuration is of type CSI-RS then the above described fourth alternative (ZP CSI-RS resources) may be used.

Multiple CLI measurement RS resources/resource sets may be configured for a single aggressor base station in different time and frequency resources so that multiple Tx beams can be measured at the same time. One or more same CLI measurement RS resources/resource sets may be configured for multiple beams as long as the sequences of one or more RSs associated with these beams are orthogonal to each other.

Regarding one or more frame structures that may be used in the above-described communication system, it will be appreciated that the base stations and the UEs communicate with one another using resources that are organised, in the time domain, into frames of length of 10 ms. Each frame comprises ten equally sized subframes of 1 ms length. Each subframe is divided into one or more slots comprising 14 Orthogonal frequency-division multiplexing (OFDM) symbols of equal length. For example, each column in FIGS. 15 to 17 may represent one OFDM symbol, in which case the 14 consecutive symbols in FIGS. 15 to 17 may represent one subframe.

However, the communication system supports multiple different numerologies (subcarrier spacing (SCS), slot lengths and hence OFDM symbol lengths). Specifically, each numerology is identified by a parameter, μ, where μ=0 represents 15 kHz (corresponding to the LTE SCS). Currently, the SCS for other values of μ can, in effect, be derived from μ=0 by scaling up in powers of 2 (i.e. SCS=15×2 kHz). The relationship between the parameter, μ, and SCS (Δf) is shown in Table 1:

TABLE 1
5G Numerology

| | | Number of slots | |
|---|---|---|---|
| μ | Δf = 2^{μ} · 15 [kHz] | per subframe | Slot length (ms) |
| 0 | 15 | 1 | 1 |
| 1 | 30 | 2 | 0.5 |
| 2 | 60 | 4 | 0.25 |
| 3 | 120 | 8 | 0.125 |
| 4 | 240 | 16 | 0.0625 |

In the above description, the UE, the access network node (base station), and the core network function are described for ease of understanding as having a number of discrete functional components or modules. Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities.

In the above example embodiments, a number of software modules were described. As those skilled in the art will appreciate, the software modules may be provided in compiled or un-compiled form and may be supplied to the UE, to the access network node (base station), or to the core network function as a signal over a computer network, or on a recording medium. Further, the functionality performed by part or all of this software may be performed using one or more dedicated hardware circuits. However, the use of software modules is preferred as it facilitates the updating of the UE, the access network node (base station), or the core network function in order to update their functionalities.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like. Various other modifications will be apparent to those skilled in the art and will not be described in further detail here.

The base station may comprise a ‘distributed’ base station having a central unit ‘CU’ and one or more separate distributed units (DUs). For example, a gNB may be split into a CU and one or more DUs, connected by the so-called F1 interface. This enables the use of a ‘split’ architecture, whereby the, typically ‘higher’, CU layers (for example, but not necessarily or exclusively), PDCP) and the, typically ‘lower’, DU layers (for example, but not necessarily or exclusively, RLC/MAC/PHY) to be implemented separately. Thus, for example, the higher layer CU functionality for a number of gNBs may be implemented centrally (for example, by a single processing unit, or in a cloud-based or virtualised system), whilst retaining the lower layer DU functionality locally, in each of the gNB.

The User Equipment (or “UE”, “mobile station”, “mobile device” or “wireless device”) in the present disclosure is an entity connected to a network via a wireless interface.

It should be noted that the present disclosure is not limited to a dedicated communication device, and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table. This list is not exhaustive and is intended to be indicative of some examples of machine type communication applications.

| Service Area | MTC applications |
|---|---|
| Security | Surveillance systems |
| | Backup for landline |
| | Control of physical access (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote Maintenance/ | Sensors |
| Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an MVNO (Mobile Virtual Network Operator) service, an emergency radio communication system, a PBX (Private Branch eXchange) system, a PHS/Digital Cordless Telecommunications system, a POS (Point of sale) system, an advertise calling system, an MBMS (Multimedia Broadcast and Multicast Service), a V2X (Vehicle to Everything) system, a train radio system, a location related service, a Disaster/Emergency Wireless Communication Service, a community service, a video streaming service, a femto cell application service, a VoLTE (Voice over LTE) service, a charging service, a radio on demand service, a roaming service, an activity monitoring service, a telecom carrier/communication NW selection service, a functional restriction service, a PoC (Proof of Concept) service, a personal information management service, an ad-hoc network/DTN (Delay Tolerant Networking) service, etc.

Further, the above-described UE categories are merely examples of applications of the technical ideas and example embodiments described in the present document. Needless to say, these technical ideas and example embodiments are not limited to the above-described UE and various modifications can be made thereto.

The method performed by the radio access network node may further comprise receiving the respective configuration information; and including at least one of the plurality of the other radio access network nodes in a list including a plurality of candidate aggressor nodes, based on the respective configuration information. In this case, the identifying the aggressor node may include identifying the aggressor node from the list.

The including may be performed based on at least one of: location information associated with the radio access network node; respective location information associated with a transmitter of a candidate aggressor node; and a characteristic of a beam associated with a transmitter of a candidate aggressor node.

The method performed by the radio access network node may further comprise: receiving beam configuration information for at least one other radio access network node. In this case, the including the one of the at least one of the plurality of the other radio access network nodes in the list may be performed based on the beam configuration information.

The method performed by the radio access network node may further comprise transmitting the list to at least one other node for managing the CLI.

The method performed by the radio access network node may further comprise: receiving a further list including information identifying at least one candidate aggressor node as a source of CLI for a cell of a further radio access network node; and managing the list based on the further list.

The method performed by the radio access network node may further comprise receiving information identifying a transmission power associated with the aggressor node.

The configuration information may include at least one of: a time division duplex configuration; a beam configuration; and location information associated with a transmitter of the plurality of the remote radio access network nodes.

The identifying the aggressor node may include measuring a CLI or a change in CLI associated with at least one candidate aggressor node of the plurality of candidate aggressor nodes whilst the at least one candidate aggressor node performs a beam sweeping operation or a nulling beam sweeping operation. The method performed by the radio access network node may further comprise identifying a beam of the aggressor node as the source of the CLI based on the beam sweeping operation or the nulling beam sweeping operation.

The identifying the aggressor node may further include reporting the CLI or the change in CLI associated with at least one candidate aggressor node to the at least one candidate aggressor node.

The beam sweeping operation may be performed for at least one of: a first set of at least one beam currently used for data transmission by the at least one candidate aggressor node; a second set of at least one beam expected to be used for data transmission by the at least one candidate aggressor node; and a third set of at least one beam not used for data transmission by the at least one candidate aggressor node.

The method performed by the radio access network node may further comprise: configuring at least one resource for measurement of the CLI; and determining a level of the CLI in the cell of the radio access network node based on a received signal strength of a CLI reference signal received from the aggressor node over the at least one resource.

The method performed by the radio access network node may further comprise transmitting, to another radio access network node, beam configuration information for at least one beam of the radio access network node, for use in identifying, by the other radio access network node, a source beam for the CLI.

A timing for the transmitting the at least one reference signal for measuring CLI may be set such that an arrival time of an uplink signal from a user equipment (UE) at another radio access network node and an arrival time of the radio transmission from the radio access network node are aligned.

In a case that downlink transmissions by the radio access network node and the other radio access network node are synchronised; the timing may be set based on a first value representing the arrival time of the uplink signal from the UE and a second value derived based on a distance between the radio access network node and the other radio access network node.

The method performed by the radio access network node may further comprise receiving information indicating an occurrence of CLI outside the serving area of the radio access network node, based on the transmitted at least one reference signal.

The received signal strength value may include at least one of: a CLI channel state information-reference signal received power (CLI CSI-RSRP) value; and a base station specific CLI received signal strength indicator (CLI-RSSI) value.

The CLI CSI-RSRP value may represent a linear average over power contribution of at least one resource element of one or more antenna port that carries CSI reference signals associated with CLI RSRP measurements within an associated measurement frequency bandwidth in at least one associated CSI-RS occasion.

The base station specific CLI-RSSI value may represent a linear average of a total received power observed in at least one Orthogonal Frequency Division Multiplexing (OFDM) symbol of at least one associated measurement time resource, in an associated measurement bandwidth from at least one source.

The at least one source may include at least one of: a co-channel serving cell; a non-serving cell; a source of adjacent channel interference; a self-interference source; and a thermal noise.

The at least one resource may include at least one of: at least one resource for a zero power (ZP) sounding reference signal (SRS); at least one punctured resource; at least one ZP CLI management resource; and at least one ZP channel state information-reference signal (CSI-RS) resource.

The configuring may include configuring a plurality of ZP SRS resources for measurement of respective CLI caused by radio transmissions from a plurality of transmitters. A comb factor for the plurality of ZP SRS resources may be selected based on a maximum number of the plurality of transmitters; and the determining may be performed for each of the plurality of transmitters based on the comb factor and a number of orthogonal codes in the code domain.

The at least one resource may include a plurality of ZP SRS or CSI-RS resources respectively associated with different beams; and the determining may include determining, for each one of the different beams, a respective level of the CLI based on a corresponding received signal strength value of a CLI reference signal received over the associated ZP SRS or CSI-RS resource.

The punctured resource may include at least one of a punctured uplink data resource and a punctured SRS resource, and the punctured resource may be configured in at least one of a time and a frequency domain.

The at least one resource may be configured in at least one of a periodic, a semi-persistent, and a dynamic manner.

The radio access network node may be configured for a sub-band full Duplex (SBFD) operation, and the at least one resource may be configured in at least one sub-band.

The information indicating the occurrence of the CLI may include at least one of: a CLI channel state information-reference signal received power (CLI CSI-RSRP) value; and a CLI received signal strength indicator (CLI-RSSI) value.

The information indicating the occurrence of the CLI may be transmitted in at least one of: a periodic report, a semi-persistent report; and an aperiodic or on-demand report.

The method performed by the radio access network node may further comprise: receiving, from the other radio access network node or an operation and maintenance node acting as the node for managing the CLI, a request for transmitting a report relating to the CLI; and transmitting the report to the other radio access network node or the operation and maintenance node, the report including the information indicating the occurrence of the CLI.

The information indicating the occurrence of the CLI may be transmitted to the node responsible for CLI management in a case that a level of the CLI is above an associated threshold.

The downlink transmissions by the radio access network node and the other radio access network node may be synchronised. In this case, a timing of the transmitting the uplink signal may be set based on a first value representing the arrival time of a downlink signal from the other radio access network node and a second value derived based on a distance between the radio access network node and the other radio access network node.

The timing may be based on a timing advance value for the UE. The timing advance value may be a negative number.

The method performed by the UE may further comprise configuring a guard period based on the timing.

Various other modifications will be apparent to those skilled in the art and will not be described in further detail here.

The whole or part of the example embodiments disclosed above can be described as, but not limited to, the following supplementary notes.

### Supplementary Note 1

A method performed by a radio access network node, the method comprising:
identifying, based on respective configuration information for determining cross link interference (CLI), relating to a plurality of other radio access network nodes, an aggressor node as a source of the CLI in a cell of the radio access network node, outside a serving area of the aggressor node.

### Supplementary Note 2

The method according to Supplementary note 1, further comprising:
receiving the respective configuration information;
including at least one of the plurality of the other radio access network nodes in a list including a plurality of candidate aggressor nodes, based on the respective configuration information, and wherein
the identifying the aggressor node includes identifying the aggressor node from the list.

### Supplementary Note 3

The method according to Supplementary note 2, wherein
the including is performed based on at least one of:
location information associated with the radio access network node;
respective location information associated with a transmitter of a candidate aggressor node; and
a characteristic of a beam associated with a transmitter of a candidate aggressor node.

### Supplementary Note 4

The method according to Supplementary note 2 or 3, further comprising:
receiving beam configuration information for at least one other radio access network node, wherein
the including the one of the at least one of the plurality of the other radio access network nodes in the list is performed based on the beam configuration information.

### Supplementary Note 5

The method according to any of Supplementary notes 2 to 4, further comprising transmitting the list to at least one other node for managing the CLI.

### Supplementary Note 6

The method according to any of Supplementary notes 2 to 5, further comprising:
receiving a further list including information identifying at least one candidate aggressor node as a source of CLI for a cell of a further radio access network node; and
managing the list based on the further list.

### Supplementary Note 7

The method according to any of Supplementary notes 1 to 6, further comprising receiving information identifying a transmission power associated with the aggressor node.

### Supplementary Note 8

The method according to any of Supplementary notes 1 to 7, wherein the configuration information includes at least one of:
a time division duplex configuration;
a beam configuration; and
location information associated with a transmitter of the plurality of the remote radio access network nodes.

### Supplementary Note 9

The method according to any of Supplementary notes 2 to 8, wherein the identifying the aggressor node includes measuring a CLI or a change in CLI associated with at least one candidate aggressor node of the plurality of candidate aggressor nodes whilst the at least one candidate aggressor node performs a beam sweeping operation or a nulling beam sweeping operation.

### Supplementary Note 10

The method according to Supplementary note 9, further comprising identifying a beam of the aggressor node as the source of the CLI based on the beam sweeping operation or the nulling beam sweeping operation.

### Supplementary Note 11

The method according to Supplementary note 9 or 10, wherein the identifying the aggressor node further includes reporting the CLI or the change in CLI associated with at least one candidate aggressor node to the at least one candidate aggressor node.

### Supplementary Note 12

The method according to any of Supplementary notes 9 to 11, wherein the beam sweeping operation is performed for at least one of:
a first set of at least one beam currently used for data transmission by the at least one candidate aggressor node;
a second set of at least one beam expected to be used for data transmission by the at least one candidate aggressor node; and
a third set of at least one beam not used for data transmission by the at least one candidate aggressor node.

### Supplementary Note 13

The method according to any of Supplementary notes 1 to 12, further comprising:
configuring at least one resource for measurement of the CLI; and
determining a level of the CLI in the cell of the radio access network node based on a received signal strength of a CLI reference signal received from the aggressor node over the at least one resource.

### Supplementary Note 14

A method performed by a radio access network node, the method comprising:
transmitting at least one reference signal for measuring cross link interference (CLI) caused, outside a serving area of the radio access network node, by radio transmission from the radio access network node.

### Supplementary Note 15

The method according to Supplementary note 14, further comprising:
transmitting, to another radio access network node, beam configuration information for at least one beam of the radio access network node, for use in identifying, by the other radio access network node, a source beam for the CLI.

### Supplementary Note 16

The method according to Supplementary note 14 or 15, wherein a timing for the transmitting the at least one reference signal for measuring CLI is set such that an arrival time of an uplink signal from a user equipment (UE) at another radio access network node and an arrival time of the radio transmission from the radio access network node are aligned.

### Supplementary Note 17

The method according to Supplementary note 16, wherein
downlink transmissions by the radio access network node and the other radio access network node are synchronised; and
the timing is set based on a first value representing the arrival time of the uplink signal from the UE and a second value derived based on a distance between the radio access network node and the other radio access network node.

### Supplementary Note 18

The method according to any of Supplementary notes 14 to 17, further comprising:
receiving information indicating an occurrence of CLI outside the serving area of the radio access network node, based on the transmitted at least one reference signal.

### Supplementary Note 19

A method performed by a radio access network node, the method comprising:
configuring at least one resource for measurement of cross link interference (CLI), outside a serving area of a transmitter, caused by radio transmissions from the transmitter; and
determining a level of the CLI based on a received signal strength value of a CLI reference signal received from the transmitter over the at least one resource.

### Supplementary Note 20

The method according to Supplementary note 19, wherein the received signal strength value includes at least one of:
a CLI channel state information-reference signal received power (CLI CSI-RSRP) value; and
a base station specific CLI received signal strength indicator (CLI-RSSI) value.

### Supplementary Note 21

The method according to Supplementary note 20, wherein the CLI CSI-RSRP value represents a linear average over power contribution of at least one resource element of one or more antenna port that carries CSI reference signals associated with CLI RSRP measurements within an associated measurement frequency bandwidth in at least one associated CSI-RS occasion.

### Supplementary Note 22

The method according to Supplementary note 20 or 21, wherein the base station specific CLI-RSSI value represents a linear average of a total received power observed in at least one Orthogonal Frequency Division Multiplexing (OFDM) symbol of at least one associated measurement time resource, in an associated measurement bandwidth from at least one source.

### Supplementary Note 23

The method according to Supplementary note 22, wherein the at least one source includes at least one of:
a co-channel serving cell;
a non-serving cell;
a source of adjacent channel interference;
a self-interference source; and
a thermal noise.

### Supplementary Note 24

The method according to any of Supplementary notes 19 to 23, wherein the at least one resource includes at least one of:
at least one resource for a zero power (ZP) sounding reference signal (SRS);
at least one punctured resource;
at least one ZP CLI management resource; and
at least one ZP channel state information-reference signal (CSI-RS) resource.

### Supplementary Note 25

The method according to Supplementary note 24, wherein
the configuring includes configuring a plurality of ZP SRS resources for measurement of respective CLI caused by radio transmissions from a plurality of transmitters;
a comb factor for the plurality of ZP SRS resources is selected based on a maximum number of the plurality of transmitters; and
the determining is performed for each of the plurality of transmitters based on the comb factor and a number of orthogonal codes in the code domain.

### Supplementary Note 26

The method according to Supplementary note 24, wherein
the at least one resource includes a plurality of ZP SRS or CSI-RS resources respectively associated with different beams; and
the determining includes determining, for each one of the different beams, a respective level of the CLI based on a corresponding received signal strength value of a CLI reference signal received over the associated ZP SRS or CSI-RS resource.

### Supplementary Note 27

The method according to Supplementary note 24, wherein the punctured resource includes at least one of a punctured uplink data resource and a punctured SRS resource, and wherein the punctured resource is configured in at least one of a time and a frequency domain.

### Supplementary Note 28

The method according to any of Supplementary notes 19 to 27, wherein the at least one resource is configured in at least one of a periodic, a semi-persistent, and a dynamic manner.

### Supplementary Note 29

The method according to Supplementary note 24 or 27, wherein
the radio access network node is configured for a sub-band full Duplex (SBFD) operation; and
the at least one resource is configured in at least one sub-band.

### Supplementary Note 30

A method performed by a radio access network node, the method comprising:
detecting, based on an associated reference signal, an occurrence of cross link interference (CLI) caused outside a serving area of another radio access network node, by radio transmission from the other radio access network node; and
transmitting information indicating the occurrence of the CLI, to a node responsible for CLI management.

### Supplementary Note 31

The method according to Supplementary note 30, wherein the information indicating the occurrence of the CLI includes at least one of:
a CLI channel state information-reference signal received power (CLI CSI-RSRP) value; and
a CLI received signal strength indicator (CLI-RSSI) value.

### Supplementary Note 32

The method according to Supplementary note 30 or 31, wherein the information indicating the occurrence of the CLI is transmitted in at least one of:
a periodic report,
a semi-persistent report; and
an aperiodic or on-demand report.

### Supplementary Note 33

The method according to any of Supplementary notes 30 to 32, further comprising
receiving, from the other radio access network node or an operation and maintenance node acting as the node for managing the CLI, a request for transmitting a report relating to the CLI; and
transmitting the report to the other radio access network node or the operation and maintenance node, the report including the information indicating the occurrence of the CLI.

### Supplementary Note 34

The method according to any of Supplementary notes 30 to 33, wherein the information indicating the occurrence of the CLI is transmitted to the node responsible for CLI management in a case that a level of the CLI is above an associated threshold.

### Supplementary Note 35

A method performed by a user equipment (UE), the method comprising:
transmitting an uplink signal such that an arrival time of the uplink signal at a radio access network node and an arrival time of a reference signal for measuring cross link interference (CLI) from another radio access network node are aligned.

### Supplementary Note 36

The method according to Supplementary note 35, wherein
downlink transmissions by the radio access network node and the other radio access network node are synchronised; and
a timing of the transmitting the uplink signal is set based on a first value representing the arrival time of a downlink signal from the other radio access network node and a second value derived based on a distance between the radio access network node and the other radio access network node.

### Supplementary Note 37

The method according to Supplementary note 35 or 36, wherein the timing is based on a timing advance value for the UE.

### Supplementary Note 38

The method according to Supplementary note 37, wherein the timing advance value is a negative number.

### Supplementary Note 39

The method according to any of Supplementary notes 36 to 38, further comprising configuring a guard period based on the timing.

### Supplementary Note 40

A radio access network node comprising:
means for identifying, based on respective configuration information for determining cross link interference (CLI), relating to a plurality of other radio access network nodes, an aggressor node as a source of the CLI in a cell of the radio access network node, outside a serving area of the aggressor node.

### Supplementary Note 41

A radio access network node comprising:
means for transmitting at least one reference signal for measuring cross link interference (CLI) caused, outside a serving area of the radio access network node, by radio transmission from the radio access network node.

### Supplementary Note 42

A radio access network node comprising:
means for configuring at least one resource for measurement of cross link interference (CLI), outside a serving area of a transmitter, caused by radio transmissions from the transmitter; and
means for determining a level of the CLI based on a received signal strength value of a CLI reference signal received from the transmitter over the at least one resource.

### Supplementary Note 43

A radio access network node comprising:
means for detecting, based on an associated reference signal, an occurrence of cross link interference (CLI) caused outside a serving area of another radio access network node, by radio transmission from the other radio access network node; and
means for transmitting information indicating the occurrence of the CLI, to a node responsible for CLI management.

### Supplementary Note 44

A user equipment (UE) comprising:
means for transmitting an uplink signal such that an arrival time of the uplink signal at a radio access network node and an arrival time of a reference signal for measuring cross link interference (CLI) from another radio access network node are aligned.

It will be appreciated by a person skilled in the art that numerous variations and/or modifications may be made to the present disclosure as shown in the specific example embodiments without departing from the spirit or scope of this disclosure as broadly described. The present example embodiments are, therefore, to be considered in all respects to be illustrative and not restrictive.

The present application is based upon and claims the benefit of priority from United Kingdom Patent Application No. 2209320.7, filed on Jun. 24, 2022, the entire contents of which are hereby incorporated by reference.

### REFERENCE SIGNS LIST

1 telecommunication system
3, 3A, 3B mobile device
5, 5A, 5B, 5C, 5D, 5E base station
7 core network
31 transceiver circuit
33 antenna
35 user interface
37 controller
39 memory
41 operating system
43 communications control module
45 CLI management module
51 transceiver circuit
53 antenna
55 network interface
57 controller
59 memory
61 operating system
63 communications control module
65 CLI management module
71 transceiver circuit
75 network interface
77 controller
79 memory
81 operating system
83 communications control module
85 CLI management module

What is claimed is:

1. A method performed by a radio access network node, the method comprising:
receiving, from at least one other radio access network node, respective configuration information for determining cross link interference (CLI); and
determining, based on the respective configuration information, an aggressor node as a source of the CLI in a cell of the radio access network node, outside a serving area of the aggressor node, and
wherein the respective configuration information includes at least one of:
a time division duplex configuration;
a subband full duplex (SBFD) time and frequency location configuration;
a Synchronization Signal/Physical Broadcast Channel (PBCH) block (SSB) configuration;
a non-zero power (NZP) Channel State Information (CSI)-Reference Signal (RS) configuration; and
location information corresponding to a transmitter of the at least one other radio access network node.

2. The method according to claim 1, wherein
the determining is performed by updating a list including information indicating at least one candidate aggressor node by including or removing information indicating the at least one other radio access network node, based on the respective configuration information, and wherein
the determining the aggressor node is performed by determining the aggressor node based on the list.

3. The method according to claim 2, wherein
the updating is performed based on at least one of:
location information corresponding to the radio access network node;
respective location information corresponding to a transmitter of the at least one candidate aggressor node; and
a characteristic of a SSB and/or NZP CSI-RS corresponding to a transmitter of the at least one candidate aggressor node.

4. (canceled)

5. The method according to claim 2, further comprising transmitting the list to at least one other node for managing the CLI.

6. The method according to claim 2, further comprising:
receiving a further list including information indicating at least one candidate aggressor node as a source of CLI for a cell of a further radio access network node; and
updating the list based on the further list.

7. The method according to claim 1, further comprising:
receiving information indicating a transmission power corresponding to the aggressor node; and
determining whether transmission of the aggressor node will interfere with the access network node.

8. (canceled)

9. The method according to claim 2, wherein the determining the aggressor node includes measuring a CLI or a change in CLI corresponding to the at least one candidate aggressor node while the at least one candidate aggressor node performs a beam sweeping operation or a nulling beam sweeping operation.

10. The method according to claim 9, further comprising determining a beam of the aggressor node as the source of the CLI based on the beam sweeping operation or the nulling beam sweeping operation.

11. The method according to claim 9, wherein the determining the aggressor node further includes reporting the CLI or the change in CLI corresponding to the at least one candidate aggressor node, to the at least one candidate aggressor node.

12. The method according to claim 9, wherein the beam sweeping operation is performed for at least one of:
a first set of at least one beam currently used for data transmission by the at least one candidate aggressor node;
a second set of at least one beam expected to be used for data transmission by the at least one candidate aggressor node; and
a third set of at least one beam not used for data transmission by the at least one candidate aggressor node.

13. The method according to claim 1, further comprising:
configuring at least one resource for measurement of the CLI; and
determining a level of the CLI in the cell of the radio access network node based on a received signal strength of a CLI reference signal received from the aggressor node over the at least one resource.

14-39. (canceled)

40. A radio access network node comprising:
a memory storing instructions; and
at least one processor configured to process the instructions to:
receive, from at least one other radio access network node, respective configuration information for determining cross link interference (CLI); and
determine, based on the respective configuration information, an aggressor node as a source of the CLI in a cell of the radio access network node, outside a serving area of the aggressor node, and
wherein the respective configuration information includes at least one of:
a time division duplex configuration;
a subband full duplex (SBFD) time and frequency location configuration;
a Synchronization Signal/Physical Broadcast Channel (PBCH) block (SSB) configuration;
a non-zero power (NZP) Channel State Information (CSI)-Reference Signal (RS) configuration; and
location information corresponding to a transmitter of the at least one other radio access network node.

41-44. (canceled)
